(19) United States
(12) Patent Application Publication
(10) Pub. No.: US 2011/0055309 A1
(43) Pub. Date: Mar. 3, 2011

(54) Communication in Context of Content

(76) Inventors: David Gibor, Or-Yehuda (IL); Igal Roytblat, Richmond Hill (CA)

(21) Appl. No.: 12/861,383

(22) Filed: Aug. 23, 2010

Related U.S. Application Data
(60) Provisional application No. 61/238,194, filed on Aug. 30, 2009.

(51) Int. Cl. G06F 15/16

(52) U.S. Cl. 709/202; 709/227; 709/206

(57) ABSTRACT

A system for communication in context of content, the system comprising an interaction data receiver, implemented on a server computer and configured to receive data indicating occurrence of an interaction of a visitor with a content item presented on a computer remote from the server computer, and a communication method selector, in communication with the interaction data receiver, configured to select at least one owner among a group of owners pre-assigned to the content item and a communication method among a group of communication methods pre-defined for the selected owner, for dynamically connecting the visitor and the selected owner, using the received data and according to a pre-defined selection criterion.

### RELATIONSHIP TO EXISTING APPLICATIONS

The present application claims priority from U.S. Provisional Patent Application No. 61/238,194, filed on Aug. 30, 2009, the contents of which are hereby incorporated by reference.

### FIELD AND BACKGROUND OF THE INVENTION

The present invention relates to communication and, more particularly, but not exclusively to communication in context of a content item.

Through the advent and proliferation of the Internet, people have used methods to communicate with anonymous visitors to content items such as ads and articles, the people place on the web.

The most basic method used is to leave an email address or a phone number for the visitor to call, say next to an advertisement on a web site.

Blog and article based sites implement Talkback Mechanisms.

A Talkback Mechanism allows visitors to leave comments beneath articles or blog entries.

Some websites implement a fixed communication channel between a web server hosting the website and a company representative, to assist visitors to the website, by offering a live chat capability with a company representative who waits for a visitor to contact him. The website presents a button on the site. When the visitor clicks on the button, a chat window opens and a conversation begins between the visitor and the company representative, over the fixed communication channel.

Another type of websites that use live chat includes social networks such as Facebook.com and dating websites such as Match.com. A website like Facebook.com or Match.com typically provides a live chat connection between a visitor and an owner of a profile presented on the website. The live chat connection is provided between the visitor and the profile owner when both parties are logged into the website at the same time.

### SUMMARY OF THE INVENTION

According to one aspect of the present invention there is provided a system for communication in context of content, the system comprising an interaction data receiver, implemented on a server computer and configured to receive data indicating occurrence of an interaction of a visitor with a content item presented on a computer remote from the server computer, and a communication method selector, in communication with said interaction data receiver, configured to select at least one owner among a group of owners pre-assigned to the content item and a communication method among a group of communication methods pre-defined for the selected owner, for dynamically connecting the visitor and the selected owner, using the received data and according to a pre-defined selection criterion.

According to a second aspect of the present invention there is provided a system for communication in context of content the system comprising: an interaction data receiver, implemented on a server computer and configured to receive data indicating occurrence of an interaction of a first party with a content item on a computer remote from the server computer, and a communication method selector, in communication with said interaction data receiver, configured to select at least one second party among a group of parties pre-assigned to the content item and a communication method among a group of communication methods pre-defined for the second party, for dynamically connecting the first party and the second party, using the received data and according to a pre-defined selection criterion.

According to a third aspect of the present invention there is provided a computer implemented method for communication in context of content, the method comprising steps the computer is programmed to perform, the steps comprising: on a server computer, receiving data indicating occurrence of an interaction of a visitor with a content item presented on a computer remote from the server computer, and automatically selecting at least one owner among a group of owners pre-assigned to the content item and a communication method among a group of communication methods pre-defined for the selected owner, for dynamically connecting the visitor and the selected owner, using the received data and according to a pre-defined selection criterion.

Unless otherwise defined, all technical and scientific terms used herein have the same meaning as commonly understood by one of ordinary skill in the art to which this invention belongs. The materials, methods, and examples provided herein are illustrative only and not intended to be limiting.

According to actual instrumentation and equipment of exemplary embodiments of the method and system of the present invention, several selected steps could be implemented by hardware or by software on any operating system of any firmware or a combination thereof.

For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 is a block diagram schematically illustrating a first exemplary system, for communication in context of content, according to an exemplary embodiment of the present invention.

FIG. 2 is a block diagram schematically illustrating a second exemplary system, for communication in context of content, according to an exemplary embodiment of the present invention.

FIG. 3 is a block diagram schematically illustrating a third exemplary system, for communication in context of content, according to an exemplary embodiment of the present invention.

FIG. 4 is a flowchart schematically illustrating a first exemplary method, for securely presenting data to a user, according to an exemplary embodiment of the present invention.

FIG. 5 is a flowchart schematically illustrating a second exemplary method, for securely presenting data to a user, according to an exemplary embodiment of the present invention.

FIG. 6 is a flowchart schematically illustrating a third exemplary method, for securely presenting data to a user, according to an exemplary embodiment of the present invention.

FIG. 7 is a block diagram schematically illustrating a fourth exemplary system, for communication in context of content, according to an exemplary embodiment of the present invention.

FIG. 8 is a block diagram schematically illustrating a fifth exemplary system, for communication in context of content, according to an exemplary embodiment of the present invention.

FIG. 9 is a block diagram schematically illustrating a sixth exemplary system, for communication in context of content, according to an exemplary embodiment of the present invention.

FIG. 10 is a block diagram schematically illustrating a seventh exemplary system, for communication in context of content, according to an exemplary embodiment of the present invention.

FIG. 11 is a block diagram schematically illustrating an eighth exemplary system, for communication in context of content, according to an exemplary embodiment of the present invention.

FIG. 12 is a block diagram schematically illustrating a ninth exemplary system, for communication in context of content, according to an exemplary embodiment of the present invention.

FIG. 13 is a block diagram schematically illustrating a tenth exemplary system, for communication in context of content, according to an exemplary embodiment of the present invention.

FIG. 14 is a block diagram schematically illustrating a first client agent, for communication in context of content, according to an exemplary embodiment of the present invention.

FIG. 15 is a block diagram schematically illustrating a second client agent, for communication in context of content, according to an exemplary embodiment of the present invention.

FIG. 16 is a block diagram schematically illustrating a third client agent, for communication in context of content, according to an exemplary embodiment of the present invention.

FIG. 17 is a block diagram schematically illustrating a fourth client agent, for communication in context of content, according to an exemplary embodiment of the present invention.

FIG. 18 is a block diagram schematically illustrating a service manager for communication in context of content, according to an exemplary embodiment of the present invention.

FIG. 19 is a block diagram schematically illustrating an account manager for communication in context of content, according to an exemplary embodiment of the present invention.

FIG. 20 is a block diagram schematically illustrating a user manager for communication in context of content, according to an exemplary embodiment of the present invention.

FIG. 21 is a block diagram schematically illustrating a chat-room, for communication in context of content, according to an exemplary embodiment of the present invention.

FIG. 22 is a block diagram schematically illustrating an instant messaging manager, for communication in context of content, according to an exemplary embodiment of the present invention.

FIG. 23 is a block diagram schematically illustrating an instant messaging client, for communication in context of content, according to an exemplary embodiment of the present invention

FIG. 24 is a block diagram schematically illustrating an eleventh exemplary system, for communication in context of content, according to an exemplary embodiment of the present invention.

FIG. 25 is a block diagram schematically illustrating a profiling engine, for communication in context of content, according to an exemplary embodiment of the present invention.

### DESCRIPTION OF THE PREFERRED EMBODIMENTS

The present embodiments comprise a system and a method for communication in context of content.

A system according to an exemplary embodiment of the present invention enables owners of content to communicate with visitors who interact with the owners' content, through a dynamically established communication channel.

For example, one or more owners of a content item (such as an advertisement, an article, a picture, a video clip, a profile, etc.) may have their content item presented on one or more web sites.

In one example, the content item is an advertisement banner presented on several web sites.

Upon interaction of a user who visits one of the web sites with the content item, say by clicking on the banner, the system selects one or more of the owners and one or more communication methods (say a telephony connection, an instant messaging service, etc.), and establishes a communication channel between the user and the owner(s), thus allowing the user and owner(s) to communicate.

The system uses a predefined criterion for selecting the owner(s) and communication method(s). For example, the criterion may be based on availability of the owners through different communication methods, on the time of day when the interaction occurs, etc., as described in further detail hereinbelow.

According to an exemplary embodiment of the present invention, there may be facilitated real-time interaction for individuals or companies who can't dedicate staff for real-time interaction with occasional visitors, but still wish to be notified when a visitor views their content on the web, and interact with the visitor in real-time.

The principles and operation of a system and a method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

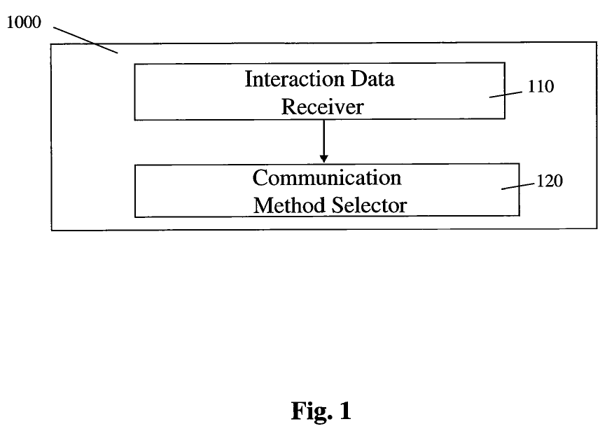

Reference is now made to FIG. 1, which is a block diagram schematically illustrating a first exemplary system, for communication in context of content, according to an exemplary embodiment of the present invention.

A system 1000 for communication in context of content, according to an exemplary embodiment of the present invention, includes an interaction data receiver 110.

The interaction data receiver 110 is implemented on a server computer, say as a computer program, as hardware, or as a combination of a computer program and hardware.

The interaction data receiver 110 receives data indicating occurrence of an interaction of a visitor with a content item presented on a computer remote from the server computer.

The server computer may be any computer, or a group of computers, which communicates with the computer remote from the server computer (through the internet, an intranet, or another network), say an application server, as described in further detail hereinbelow.

The content item may be an advertisement, an article, a picture, a video clip, a Flash banner, etc., as described in further detail hereinbelow.

Optionally, the content item is presented on one or more web pages, as described in further detail hereinbelow.

In one example, the content item is a logo presented on one or more web sites, and the interaction data receiver 110 receives data indicating that a visitor (say a user surfing the web) who visits one of the web pages, clicks on the logo, clicks on a button presented next to the logo, etc.

System 1000 further includes a communication method selector 120, in communication with the interaction data receiver 110.

The communication method selector 120 is implemented on the server computer, say as a computer program, as hardware, or as a combination of a computer program and hardware.

The communication method selector 120 selects one or more owner(s) among a group of owners pre-assigned to the content item and a communication method among a group of communication methods pre-defined for the selected owner, for dynamically connecting the visitor and the selected owner, as described in further detail hereinbelow.

The group of owners pre-assigned to the content item includes one or more owners, as described in further detail hereinbelow.

Examples to such groups may include, but are not limited to members of a family who post an ad on the Internet to sell their house, or company employees who provide answers related to a specific product or to a specific geographical region.

The group of communication methods pre-defined for the owner includes one or more communication methods, as described in further detail hereinbelow.

The communication methods pre-defined for the owner may include, but are not limited to methods based on an instant messaging service (such as Google™ Talk Microsoft™ Messenger, or Yahoo™ Messenger), Voice over Internet Protocol (VoIP), Short Messages Services (SMS), a Cellular Telephony Network, a Public Switched Telephone Network (PSTN), etc., as described in further detail hereinbelow.

The communication method selector 120 selects the owner and the communication method, using the received data, and according to a pre-defined selection criterion. In one example, the selection criterion is based, at least partially, on availability of an owner through a communication method, as described in further detail hereinbelow.

In one example, the interaction data receiver 110 may receive data indicating occurrence of interaction of several visitors. More specifically, the received data includes several data records from different origins (say different client agents, as described in further detail hereinbelow). Each of the data records indicates that a certain visitor interacts with a respective content item presented on a respective computer remote from the server computer.

Consequently, the communication method selector selects one or more owner(s) and a communication method for each of the content items the visitors interact with, as described in further detail hereinbelow.

Optionally, the visitor and the selected owner are available through different communication methods (say through different instant messaging services), as described in further detail hereinabove.

Optionally, system 1000 further includes an owner communication method definer.

The owner communication method definer is operable by a user (say one of the owners or a system administrator), for defining a group of communication methods for an owner.

Optionally, system 1000 further includes a content owner assigner.

The content owner assigner is operable by a user (say one of the owners or a system administrator), for assigning a group of owners to a content item.

Optionally, system 1000 also includes an availability data provider.

The availability data provider provides the visitor with data indicative of availability of at least a first owner pre-assigned to the content item, through at least one communication method pre-defined for the first owner.

Optionally, the content item is an object of an application which runs on a computer used by the visitor (say an entry in a Microsoft™ Outlook address book), as described in further detail hereinbelow.

Optionally, system 1000 further includes a client agent.

The client agent communicates with the interaction data receiver 110, over a network such as the Internet, an organizational intranet network, etc. The client agent sends the data indicating occurrence of the interaction to the interaction data receiver 110, as described in further detail hereinbelow.

Optionally, the client agent is embedded in the content item itself, say in a Flash movie or a Microsoft™ Sliverlight movie. The client agent may also be implemented using HTML5 (Hyper Text Markup Language 5), be based on Pop-up, etc., as described in further detail hereinbelow.

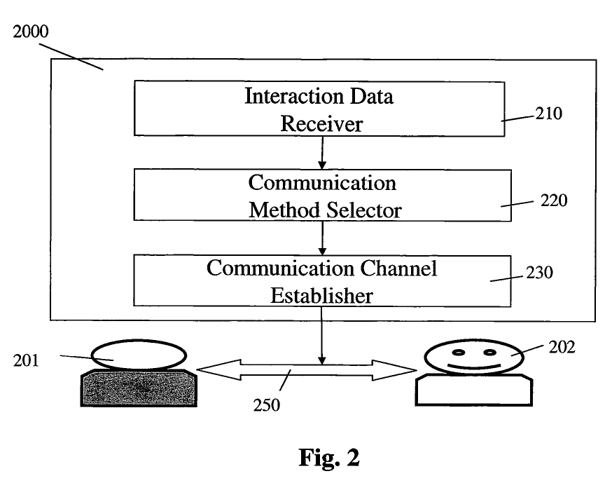

Reference is now made to FIG. 2, which is a block diagram schematically illustrating a second exemplary system, for communication in context of content, according to an exemplary embodiment of the present invention.

A system 2000 for communication in context of content, according to an exemplary embodiment of the present invention, includes an interaction data receiver 210.

The interaction data receiver 210 is implemented on a server computer, say as a computer program, as hardware, or as a combination of a computer program and hardware.

The interaction data receiver 210 receives data indicating occurrence of an interaction of a visitor 201 with a content item presented on a computer remote from the server computer.

The server computer may be any computer, or a group of computers, which communicates with the computer remote from the server computer (through the internet, an intranet, or another network), say an application server, as described in further detail hereinbelow.

The content item may be an advertisement, an article, a picture, a video clip, a Flash banner, etc., as described in further detail hereinbelow.

Optionally, the content item is presented on one or more web pages, as described in further detail hereinbelow.

In one example, the content item is a picture presented on one or more web sites, and the interaction data receiver 210 receives data indicating that a visitor (say a user who surfs the web) who visits one of the web pages, clicks on the picture, clicks on a button presented next to the picture, maximizes the picture, etc.

System 2000 further includes a communication method selector 220, in communication with the interaction data receiver 210.

The communication method selector 220 is implemented on the server computer, say as a computer program, as hardware, or as a combination of a computer program and hardware.

The communication method selector 220 selects one or more owner(s) 202 among a group of owners pre-assigned to the content item and a communication method among a group of communication methods pre-defined for the owner 202, for dynamically connecting the visitor 201 and the selected owner 202, as described in further detail hereinbelow.

The group of owners pre-assigned to the content item includes one or more owners, as described in further detail hereinbelow.

The group of communication methods pre-defined for the owner includes one or more communication methods, as described in further detail hereinbelow.

The communication methods pre-defined for the owner 202 may include, but are not limited to methods based on an instant messaging service (such as Google™ Talk or ICQ™), Voice over Internet Protocol (VoIP), Short Messages Services (SMS), a Cellular Telephony Network, a Public Switched Telephone Network (PSTN), etc.

The communication method selector 220 selects the owner 202 and the communication method, using the received data, and according to a pre-defined selection criterion. In one example, the selection criterion is based, at least partially, on availability of an owner 202 through a communication method, as described in further detail hereinbelow.

In one example, the interaction data receiver 210 may receive data indicating occurrence of interaction of several visitors. More specifically, the received data includes several data records from different origins (say different client agents, as described in further detail hereinbelow). Each of the data records indicate that a certain visitor 201 interacts with a respective content item presented on a respective computer remote from the server computer.

Consequently, the communication method selector selects one or more owner (s) 202 and a communication method for each of the content items the visitors interact with, as described in further detail hereinbelow.

System 2000 further includes a communication channel establisher 230, in communication with the communication method selector 220.

The communication channel establisher 230 dynamically establishes a communication channel 250 connecting the visitor 201 and the selected owner 202, using the selected communication method, as described in further detail hereinbelow.

Optionally, the system 2000 further includes a message enhancer.

The message enhancer enhances a message transmitted through the established communication channel 250, by inserting advertising material into the message or next to the message, by correcting spelling and grammar, by automatically translating the message into another language, etc., as described in further detail hereinbelow.

Optionally, the visitor 201 and the selected owner 202 use different communication methods (say different instant messaging services, VoIP and regular PSTN telephony, etc., as known in the art). The communication channel establisher 230 may mediate between the different communication methods, using the communication channel 250, as described in further detail hereinbelow.

Optionally, system 2000 further includes an owner communication method definer.

The owner communication method definer is operable by a user (say one of the owners 202 or a system administrator), for defining a group of communication methods for a respective owner 202.

Optionally, the owner communication method definer is further operable for assigning an owner 202 to a content item.

Optionally, system 2000 also includes an availability data provider.

The availability data provider provides the visitor 201 with data indicative of availability of at least a first owner 202 pre-assigned to the content item, through at least one communication method pre-defined for the first owner 202.

Optionally, the content item is an object of an application which runs on a computer used by the visitor 201 (say an entry in a Microsoft™ Outlook address book), as described in further detail hereinbelow.

Optionally, system 2000 further includes a client agent.

The client agent communicates with the interaction data receiver 210, over a network such as the Internet or an intranet network. The client agent sends the data indicating occurrence of the interaction to the interaction data receiver 210, as descried in further detail hereinbelow.

Optionally, the client agent is embedded in the content item itself, say in a Flash movie or a Microsoft™ Sliverlight movie. The client agent may also be implemented using HTML5 (Hyper Text Markup Language 5), be based on Pop-up, etc., as described in further detail hereinbelow.

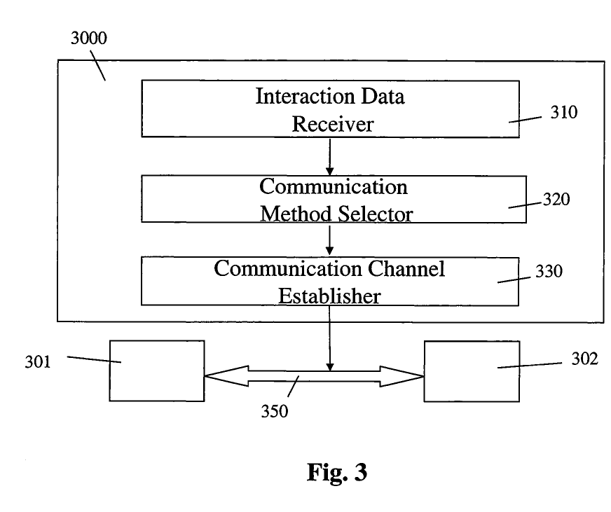

Reference is now made to FIG. 3, which is a block diagram schematically illustrating a third exemplary system, for communication in context of content, according to an exemplary embodiment of the present invention.

A system 3000 for communication in context of content, according to an exemplary embodiment of the present invention, includes an interaction data receiver 310.

The interaction data receiver 310 is implemented on a server computer, say as a computer program, as hardware, or as a combination of a computer program and hardware.

The interaction data receiver 310 receives data indicating occurrence of an interaction of a first party 301 with a content item on a computer remote from the server computer.

The server computer may be any computer, or a group of computers, which communicates with the computer remote from the server computer (through the internet, an intranet network, or another network), say an application server, as described in further detail hereinbelow.

System 3000 further includes a communication method selector 320, in communication with the interaction data receiver 310.

The communication method selector 320 is implemented on the server computer, say as a computer program, as hardware, or as a combination of a computer program and hardware.

The communication method selector 320 selects one (or more) second parties 302 among a group of parties pre-assigned to the content item.

The communication method selector 320 further selects a communication method among a group of communication methods pre-defined for the second party 302.

The communication method selector 320 selects the second party 302 and the communication method, for dynamically connecting the first party 301 and the second party 302, using the received data and according to a pre-defined selection criterion, as described in further detail hereinbelow.

Optionally, system 3000 further includes a communication channel establisher 330.

The communication channel establisher 330 dynamically establishes a communication channel 350 connecting the parties 301, 302, using the selected communication method.

Optionally, at least one of the parties 301, 302, is a computer application, as described in further detail hereinbelow.

Optionally, system 3000 further includes a screen sharing manager.

The screen sharing manager uses the established communication channel 350, for sharing screen content between the first party 301 and the second party 302, as described in further detail hereinbelow.

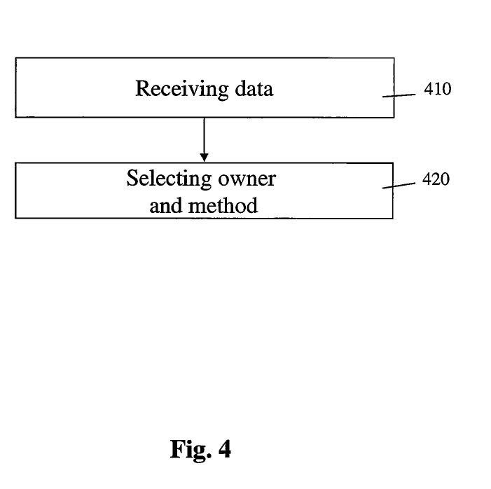

Reference is now made to FIG. 4, which is a flowchart schematically illustrating a first exemplary method, for communication in context of content, according to an exemplary embodiment of the present invention.

A method for communication in context of content, according to an exemplary embodiment of the present invention may be implemented on a server computer, as described in further detail hereinabove.

In the method, there is received 410 data indicating occurrence of an interaction of a visitor with a content item presented on a computer remote from the server computer.

The server computer may be any computer, or a group of computers, which communicates with the computer remote from the server computer (through the internet, an intranet network, or another network), say an application server, as described in further detail hereinbelow.

Optionally, the data is received 410 by the interaction data receiver 210, as described in further detail hereinabove.

The content item may be an advertisement, an article, a picture, a video clip, a Flash banner, a profile, a webpage, etc., as described in further detail hereinbelow.

Optionally, the content item is presented on one or more web pages, as described in further detail hereinbelow.

In one example, the content item is a job advertisement presented on one or more web sites, the received 410 data indicates that a visitor (say a job seeker) who visits one of the web page, clicks on the advertisement.

Next, there is selected 420 one or more owner(s) among a group of owners pre-assigned to the content item and a communication method among a group of communication methods pre-defined for the owner 202, for dynamically connecting the visitor 201 and the selected owner 202.

Optionally, the owner and the communication method are selected 420 using the communication method selector 220, as described in further detail hereinbelow.

The group of owners pre-assigned to the content item includes one or more owners, as described in further detail hereinbelow.

Exemplary groups of owners include, but are not limited to members of a family who post an ad on the Internet to sell their house, company employees who provide answers related to a specific product offered by the company on several shopping websites such as eBay™, etc.

The group of communication methods pre-defined for the owner includes one or more communication methods, as described in further detail hereinbelow.

The communication methods pre-defined for the owner may include, but are not limited to methods based on an instant messaging service (such as Google™ Talk or ICQ™), Voice over Internet Protocol (VoIP), Short Messages Services (SMS), a Cellular Telephony Network, a Public Switched Telephone Network (PSTN), etc.

The communication method selector 220 selects the owner and the communication method, using the received data, and according to a pre-defined selection criterion. In one example, the selection criterion is based, at least partially, on availability of an owner through a communication method, as described in further detail hereinbelow.

In one example, there is received 410 data indicating occurrence of interaction of several visitors. More specifically, the received data includes several data records from different origins (say different client agents, as described in further detail hereinbelow). Each of the data records indicates that a certain visitor interacts with a respective content item presented on a respective computer remote from the server computer.

Consequently, there is selected 420 one or more owner(s) and a communication method for each of the content items the visitors interact with, as described in further detail hereinbelow.

Next, there may be dynamically established a communication channel connecting the visitor and the selected owner using the selected communication method, say by the communication channel establisher 230, as described in further detail hereinbelow.

Optionally, a message transmitted through the established communication channel is enhanced by inserting advertising material into the message or next to the message, by correcting spelling and grammar, etc., as described in further detail hereinbelow.

Optionally, there is furthered gathered extract and collect predefined data from a communication channel between the visitor and the selected owner, say statistical data, etc., as descried in further detail hereinbelow.

Optionally, the visitor and the selected owner use different communication methods (say different instant messaging services, PSTN and VoIP, etc., as known in the art). The communication channel establisher 230 may mediate between the different communication methods, using the communication channel, as described in further detail hereinbelow.

Optionally, the first exemplary method further includes a preliminary step of allowing a user (say one of the owners or a system administrator) to define a group of communication methods for a respective owner. The user may define the group of communication methods, using the owner communication method definer, as described in further detail hereinabove.

Optionally, the first exemplary method further includes a preliminary step of allowing a user to assign an owner to a content item, say using the content owner assigner, as described in further detail hereinabove.

Optionally, the visitor may be provided with data indicative of availability of at least a first owner pre-assigned to the content item, through at least one communication method pre-defined for the first owner, as described in further detail hereinbelow.

Optionally, the content item is an object of an application which runs on a computer used by the visitor (say an entry in a Microsoft™ Outlook address book), as described in further detail hereinbelow.

A method according to an exemplary embodiment of the present invention, implemented using systems like systems 1000-3000, described in further detail hereinabove, may allow content owners to reach several people through a variety of communications methods available to the content owners.

Optionally, the owners of a content item placed on one or more webpage(s) need not be logged into a specific website or install any special software on their computers or mobile devices. Consequently, the availability to website visitors of individuals or companies who own the content item may be significantly improved.

Preferably, an exemplary system according to an exemplary embodiment of the present invention, is not restricted to websites only, but may serve as a communications platform that connects individuals or computer applications over several networks, and in a variety of message formats (text, video, audio, etc.).

Optionally, the exemplary system works for websites which have content owned by many different entities, such as classified ad sites, auction sites, business directories, blog sites, photography sites and many more.

One example to such entities includes individual people who post an ad in an ad bulletin board, and wish to have the ability to chat or speak in real-time with visitors who read their ad.

A second example is blogger, who posts on the web, and wishes to interact on line with readers of his blog.

In both examples, traffic to the content item (say the ad or the blog) does not justify a dedicated operator, to sit and wait for a visitor interaction.

According to exemplary embodiments of the present invention, there is provided a method, which enables multiple ways to dynamically connect members of a group of people who place a content item on the web and visitors who view the content item placed on the web.

A system like systems 1000-3000 may also facilitate a communication channel between the visitor and the owner, through a variety of textual, audio or video communication methods, and through various communication platforms, such as a personal computer, a fixed or mobile phone, etc.

In one example, the visitor further communicates with the content owner through a text based chat window that opens in the visitor's web browser. The content owner uses a desktop or a mobile computer, to reply either from a specific webpage, a proprietary client or from a standard instant messaging client (such as Skype™, AIM™, MSN™ Messenger, Yahoo™ Messenger, Google™ Talk, etc.), as described in further detail hereinbelow.

In a second example, the visitor communicates with the content owner through a text based chat window that opens in the visitor's web browser. The content owner uses a smart mobile phone (such as an Apple™ iPhone or a RIM™ Blackberry smart phone), to reply either from a specific webpage, a proprietary client or from a standard instant messaging client (such as Skype™, AIM™, MSN™ Messenger, Yahoo™ Messenger, Google™ Talk, etc.), as described in further detail hereinbelow.

In a third example, the visitor communicates with the content owner through a text based window that opens in his web browser. The content owner receives the visitor's text message as an SMS (Short Messages Services) message to his mobile phone. Optionally, the owner replies using an SMS message presented in the visitor's text window. Alternatively, the owner sends an SMS message directly to the visitor's mobile phone (provided the visitor's phone number is disclosed by the visitor). The owner may also initiate, or offer to initiate a voice call with the visitor, as described in further detail hereinbelow.

In a fourth example, the visitor communicates with the content owner through a voice connection from the visitor's computer. This connection is a Voice over IP connection which runs directly from the visitor's web browser using Flash or similar technology, as known in the art.

Alternatively, the visitor may use a client application installed on the visitor's computer such as an instant messaging client or another proprietary software component. The content owner uses a similar method to communicate verbally with the visitor from the visitor's computer, as described in further detail hereinbelow.

In a fifth example, the owner and the visitor communicate using Voice over IP. However, either the owner or the visitor uses a mobile phone, such as an Apple™ iPhone or a RIM™ Blackberry smart phone, as described in further detail hereinbelow.

In a sixth example, the visitor communicates with the owner through a voice connection from the visitor's computer or mobile device. This connection is a Voice over IP connection which runs directly from the visitor's browser using Adobe™ Flash or a similar technology. Alternatively, the visitor's voice connection is implemented using a software component installed on the visitor's computer, say using an instant messaging client, as described in further detail hereinbelow.

In the sixth example, the communication channel establisher 230 (described in further detail hereinabove) converts the VoIP to standard audio signal and delivers the audio signal through a landline or mobile network, to a phone used by the owner.

That is to say that the communication channel establisher 230 mediates between the VoIP communication method used by the visitor and the landline (or mobile) telephony communication method used by the owner. In some cases, the conversion is not required as the owner uses VoIP technology in his phone.

In a seventh example, the communication channel establisher 230 initiates a regular voice call between the visitor's phone and the owner's phone. Any of the two phones may be a mobile phone or a landline phone, as described in further detail hereinbelow.

The communication channel establisher 230 needs to know the visitor's phone number in order to initiate the call. Optionally, the communication channel establisher 230 receives the phone number from the visitor, or from a cookie previously stored on the visitor's computer. The owner's phone number is input to the system 2000 by an authorized administrator, as described in further detail hereinabove, and is thus known to the communication channel establisher 230.

In an eighth example, the visitor communicates with the owner through a video connection that runs on the visitor's computer or mobile device.

The connection is a video and VoIP connection which runs directly on a web browser (such as Microsoft™ Internet Explorer) using Adobe™ Flash or a similar technology. Alternatively, the visitor's voice connection is implemented using a software component installed on the visitor's computer, say using an instant messaging client with video functionality, as known in the art.

The content owner may use a similar method to communicate visually and verbally with the visitor, from the owner's computer or mobile device. Optionally, the owner uses a standard instant messaging client or a socket-based client, to communicate with the visitor, as described in further detail hereinbelow.

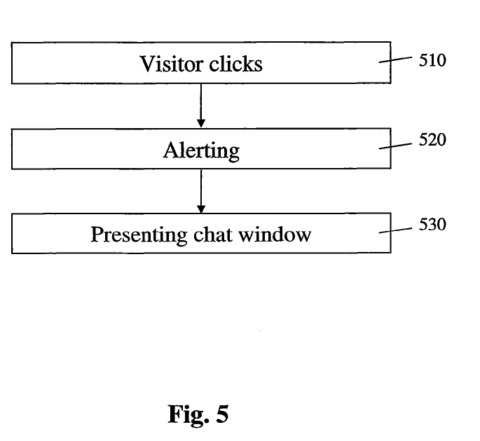

Reference is now made to FIG. 5, which is a flowchart schematically illustrating a second exemplary method, for communication in context of content, according to an exemplary embodiment of the present invention.

In a second method, according to an exemplary embodiment of the present invention, the visitor views a webpage on his browser and the content owner is available through an instant messaging service (say Skype™).

When the visitor clicks 510 on a button placed next to the content item, the owner is alerted 520 on the fact that a visitor wishes to chat. Next, the visitor is presented 530 a chat window, through which the visitor may send messages to the owner and see the owner's replies.

The owner sees the conversation in his instant messaging service client.

If the owner rather uses a socket-based client, which is installed on the owner's computer or mobile device, the owner receives the alert 520 and chats from the owner's socket-based client instead of the instant messaging service client.

If the owner rather uses SMS, the owner receives the alert and sends the chat messages to the visitor, as SMS messages from his mobile phone. Optionally, the visitor is asked for the visitor's phone number, and the owner replies to the visitor in SMS messages sent directly to the visitor's phone.

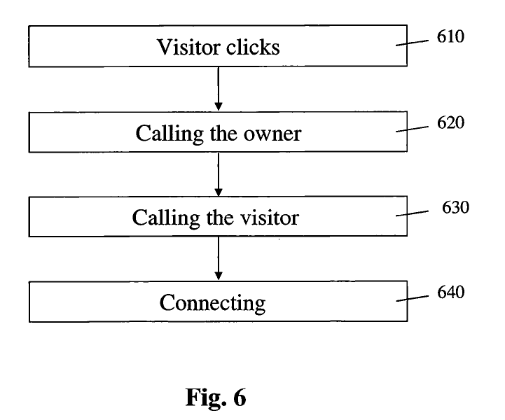

Reference is now made to FIG. 6, which is a flowchart schematically illustrating a third exemplary method, for securely presenting data to a user, according to an exemplary embodiment of the present invention.

In a third method, according to an exemplary embodiment of the present invention, the visitor and the owner communicate using their voice phones.

In the third method, the visitor views a content item presented on a web page, using a web browser (say Google™ Chrome) installed on the visitor's smart phone.

When the visitor clicks 610 on a button presented next to the content item, the communication channel establisher 230 of system 2000 calls a selected owner pre-assigned to the content item, as described in further detail hereinabove. The communication channel establisher 230 calls 620 the owner, without revealing the owner's phone number to the visitor.

If the owner does not answer, a message is presented to the visitor and the visitor is allowed to leave an SMS message to the owner. If the content owner answers the call, the communication channel establisher 230 calls 630 the visitor's phone as shown.

Once the visitor answers the call, the owner and the visitor are connected 640, and start communicating using their phones.

Exemplary uses for a system according to an exemplary embodiment of the present invention may include, but are not limited to:
a. Ad sites—people post an ad, and if a visitor reads the ad, the visitor may interact with the people, ask questions, negotiate a price and buy a product promoted using the ad.
b. Company websites—people may interact with product specialists, sales people, support people, executives, etc. A company's website may be used by external visitors to the company's Internet website, for internal visitors such as company employees (say in an Intranet portal), etc.
c. Personal web pages—individual web pages, or pages in social networking or dating sites such as Facebook.com, Myspace.com, LinkedIn.com, Plaxo.com, Match.com, etc.
d. Sites in which people post content and visitors are allowed to comment on the content posted, such as: Blog sites, Video submission sites, Author writing sites, News sites, etc. Readers may be allowed, in addition to posting comments, to chat live with the author (when the author is online) and between themselves.
e. E-Commerce, Auction, Job posting sites. The sites match between people or companies that sell or provide a service, and potential clients. Some examples are: Ebay.com, Elance.com, etc.
f. Any two applications, which are connected through a computer network, and need a platform that can offer them ad-hoc connectivity.

A system according to exemplary embodiments of the present invention may introduce new connectivity methods between a visitor and a content owner who is not online, say through SMS (Short Messages Services), as described in further detail hereinbelow.

Optionally, the exemplary system also introduces a new level of privacy.

For example, a content owner who submits content items to a shared website without revealing contact details may still want visitors to contact him. The exemplary system may establish such a connection without disclosing private contact details between the parties.

For performance assessment, the exemplary system may allow a content owner to see detailed viewing statistics of his content item, without owning the website the content item is presented on, as described in further detail hereinbelow.

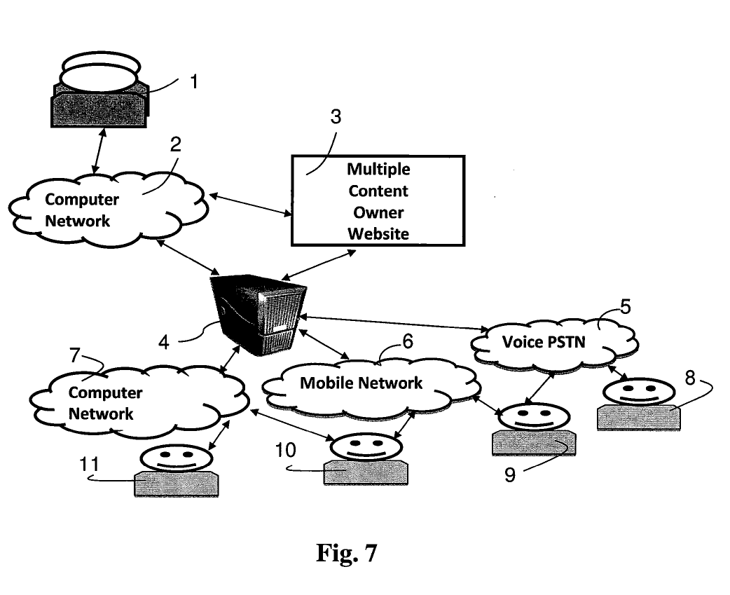

Reference is now made to FIG. 7, which is a block diagram schematically illustrating a fourth exemplary system, for communication in context of content, according to an exemplary embodiment of the present invention.

A system 4, according to an exemplary embodiment of the present invention is implemented on a computer server, say an application server, as known in the art.

The system 4 allows multiple content owners 8-11 (say companies or individuals) to communicate with visitors 1.

In one example, the owners 8-11 place their content items on a multiple content owner website 3.

A multiple content owner website 3 is a web site, which allows placement of content items owned by different owners, such as a classified ads website, a blog site, a photography site, a video site (such as YouTube), a social networking site (such as Facebook), a writing sites, etc.

Optionally, system 4 further includes a content owner assigner, which allows an owner to assign a group of owners to a content item the owners own, as described in further detail hereinabove.

Optionally, system 4 further includes an owner communication method definer, which allows an owner to define one or more communication methods for himself, as described in further detail hereinabove.

Optionally, the communication method definer rather allows only an authorized administrator to define the communication method(s) for the owner.

Optionally, in the website 3, there is placed a button next to each of the content items placed on the web site 3.

Optionally, when a visitor 1 views the content item, the system 4 notifies owners of the content item viewed that a potential call may happen soon.

When the visitor 1 clicks on the button, the system 4 receives data which indicates that the visitor 1 interacts with the content item, through a computer network 2, such as the internet.

Consequently, the system 4 establishes a connection between the visitor 1 and one or more of the content owner 8-13. More specifically, the system 1 selects one or more of the content owners assigned to the content item and one of the communication methods defined for each of the selected owners, as described in further detail hereinabove.

Optionally, the owner and communication methods are selected, according to availability of the owners assigned to the content item, through each communication methods defined for the assigned owners, say using tracking of the availability of the owners, as described in further detail hereinbelow.

For example, the system 4 may track the availability of one or more of the content's owners, on the owner's Internet-enabled mobile device or computer, say using the owner's status as indicated by the owner's instant messaging service (say the owner's ICQ™ account), as described in further detail hereinbelow.

In one example, for each of the owners 8-11, there is defined a communication method, such as communication over a computer network 7 such as the Internet, over a mobile telephony network 6, over PSTN (public switched telephone network) 5, etc., as described in further detail hereinabove.

For example, owner 8 is available only through PSTN 5, owner 9 is available through PSTN 5 as well as through the mobile network 6, owner 10 is available through the mobile network 6 as well as through the computer network 7, and owner 11 is available only through the computer network 7.

Optionally, neither the owner's contact information nor the visitor's contact information is disclosed unless they choose to disclose it. The system 4 stores both owner and visitor contact information, and establishes a communication channel between the two automatically, without revealing information such as phone numbers, caller IDs, email addresses or any other user information.

Optionally, owners may choose to use nicknames or any other information about themselves, depending on system defaults or specific settings, as known in the art.

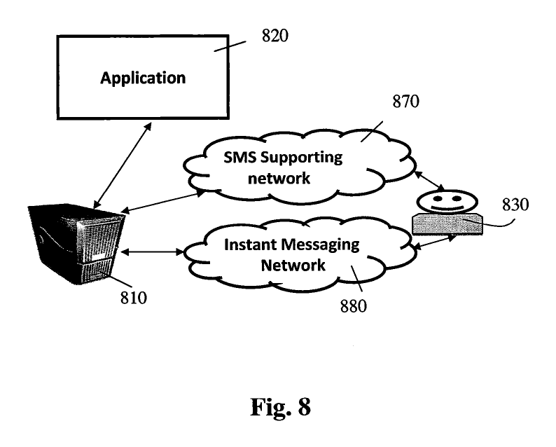

Reference is now made to FIG. 8, which is a block diagram schematically illustrating a fifth exemplary system, for communication in context of content, according to an exemplary embodiment of the present invention.

A system according to an exemplary embodiment of the present invention, may by implemented on an application server 810, as described in further detail and illustrated using FIG. 2 hereinabove.

The application server 810 communicates through one or more networks, such as an SMS supporting network 870 or an instant messaging network 880.

In one example, the system may dynamically establish communication channels between a computer application 820 and one or more owners 830.

The application may include, but is not limited to:
An employee monitoring system, which records the time in which owners 830 who are employees are active on their computers, by monitoring the availability of instant messaging clients installed on the computers of the employees 830.
An immediate notification system, say an application which sends an instant message to a group of owners 830, either to the owners' 830 clients of IM (instant messaging (IM) services (say Skype™) or by SMS. The system may decide which IM service to use for each owner 830, according to the owner's availability on one or more instant messaging services the owner 830 uses, or according to other availability rules (say a schedule of days on which the owner 830 is available). The immediate notification system may include, but is not limited to: an auction system (which notifies on a closing auction in an auction site), a corporate Microsoft™ Outlook server (which alerts on a change in a meeting time), a system which sends time-sensitive messages to friends in a social network, governmental alert system (which issues security alert messages), etc.
An application which allows time or location based promotions, say an application for advertising promotions which are time and location dependent.
Automatic query systems, in which a question is sent to the application, and the application replies through an instant messaging service or SMS.
Automated voting systems, which receives votes in SMS or in an instant messaging format.
Polling systems which may ask multiple visitors a question and receive their answers immediately.

Optionally, the exemplary system is implemented as a socket based solution, in which the owner 830 has to connect to the communication channel establisher 330, say through a log-in procedure, before the owner 830 may receive messages from the application 820, as described in further detail hereinabove.

In one exemplary socket based solution, there is installed a computer application on the computer or mobile device used by the owner 830, for connecting to the communication channel establisher 330.

In a second exemplary socket based solution, in order to be connected to the communication channel establisher 330, the owner 830 uses a standard web browser (such as Google™ Chrome), to log into the exemplary system of the present invention, say through a web site. The owner 830 identifies himself using login data, or using a cookie installed on the owner's 830 computer, as known in the art.

In a third exemplary socket based solution, in order to connect to the communication channel establisher 330, the owner 830 uses a standard web browser (such as Google™ Chrome) or another computer program, to log into a mediating system. Then, the mediating system connects the owner to the communication channel establisher 330.

Consequently, the communication channel establisher 330 may forward messages from the application 820, by dynamically establishing a communication channel between the owner 830 and the application 820, as described in further detail hereinabove, and illustrated using FIG. 3.

For example, the mediating system may be an organizational instant messaging service, a corporate Microsoft™ Exchange Server, a RIM™ Blackberry Server, etc., as known in the art, etc., as described in further detail hereinbelow.

The mediating system mediates between the owner and the communication channel establisher 330, for establishing a socket based connection between the owner and the communication channel establisher 330.

After the owner connects to the communication channel establisher 330, and upon an interaction of a visitor (who is a user of the application 820) with a content item which the owner 830 is assigned to, the communication channel establisher 330 establishes a communication channel between the owner 830 and the application 820.

Consequently, the communication channel establisher 330 mediates between the application 820 and the owner 830, and allows communications between the application 820 and the owner 830, as described in further detail hereinabove.

In a working place example, the application 820 is an enterprise Microsoft™ Outlook Sever and the visitor is a team leader who schedules a meeting for employees in the team's calendar, through the application 820.

In the working place example, the employees are pre-assigned as owners 830, to the calendar which is the content item of the working place example, say using the content owner assigner, as described in further detail hereinabove.

Upon the scheduling of the meeting, all employees receive a message, which notifies on the scheduled meeting. Each employee (i.e. owner 830), receives the message through a communication method the owner uses and is available through at the message's sending time.

In one example, the application uses an instant messaging service, to communicate with the owner 830, say a Skype™, as described in further detail hereinabove. The owner may reply and confirm his participation in the meeting, using the owner's instant messaging service client. Consequently, the application updates the scheduled meeting accordingly.

In a second example, the application uses an SMS message to communicate with the owner 830, as described in further detail hereinabove. The owner can reply and confirm his participation in the meeting, by sending a reply SMS message from his mobile phone. Consequently, the application updates the scheduled meeting accordingly.

In a third example, the application calls the owner 830, and informs him of the meeting verbally, using a voice recording or text to speech technology. The owner replies verbally and confirms his participation in the meeting. Then, the system uses speech recognition technology to convert the verbal reply to text, as described in further detail hereinbelow. Finally, the application updates the scheduled meeting accordingly.

Optionally, some of the exemplary system's components are located on a server computer, say the application server 810, whereas other components are located on other computers.

For example, some of the exemplary system's components may be located on a client agent loaded into a visitor's browser, and some system components may be located in a desktop application installed on a content owner's computer or mobile device. Since all the system components are connected by a network, the location of the various functions of the system may differ.

Examples for reasons to move physical location of system components are: IT Security aspects (say company intranet or firewall policies, costs, bandwidth limitations, server loads, delay reasons, to improve performance, etc.), as known in the art.

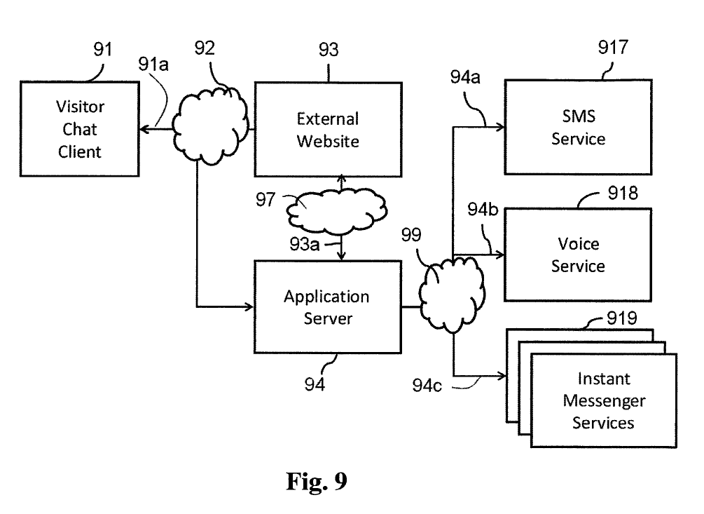

Reference is now made to FIG. 9, which is a block diagram schematically illustrating a sixth exemplary system, for communication in context of content, according to an exemplary embodiment of the present invention.

A web site 93 presents content items owned by several owners, as described in further detail hereinabove.

An exemplary system 2000, as described in further detail hereinabove, may provide a visitor to the web site 93, with availability status of each of the presented content items. The availability status is a combined representation of availability of a group of owners assigned to the content owner, as described in further detail hereinabove.

More specifically, the information about the availability of the content owners is provided to the website 93 by the system 2000, implemented on a server computer.

In one example, the system 2000 is implemented on an application server 94 in communication with the website 93 visited by the visitor, over a network 97 such as the internet or an enterprise intranet network, as described in further detail hereinabove.

When a visitor who surfs the internet 92, visits the website 93 and clicks on a button presented next to a content item or on the content item itself, a visitor chat client 91 is launched.

Optionally, the visitor chat client 91 is a dynamic application which automatically downloads and runs on the visitor's web browser. Alternatively, the visitor chat client 91 is a computer program which may be installed on the visitor's computer such as an instant messaging client, etc., as known in the art.

Optionally, the visitor's chat client is a plug-in module into web platforms, such as Wordpress, Joomla, Drupal, e-commerce packages, etc., as known in the art.

The visitor chat client 91 sends data, which indicates that the visitor interacts with the content item to the system implemented on the application server 94.

Upon receiving the data indicating the interaction, the system implemented on the application server 94 selects one or more of owners of the content item interacted with, as well as a communication method, according to a criterion predefined by an administrator, as described in further detail hereinbelow.

The system implemented on the application server 94 connects the visitor to one or more of the owners, through a communication network 99.

The system implemented on the application server 94 may connect the visitor with several owners simultaneously, let any of the selected owners answer, or let more than one owner communicate with the visitor simultaneously.

If none of the owners assigned to the content items is available, the system may reach one or more of the owners through the network 99, through of SMS, email, or through a voice message left on an answering machine.

The system may use one or more networks 99 for reaching the owners, including, but is not limited to: PSTN, Mobile Voice, Mobile SMS, Mobile Data, Instant Messengers, Internet, etc., as described in further detail hereinabove.

In order to facilitate communication between the system on the application server 94 and visitors and content owners, through a variety of communication methods, the application server 94 uses a variety of communication connections.

For example, the application server 94 may connect the application server 94 to the visitor's client 91, using a communication connection 91a, which delivers incoming chat messages, and dispatches outgoing messages. The messages are transmitted through connection 91a, as XML (Extensible Markup Language) packets or other packets, as known in the art.

Connection 91a may be continuous or intermittent as long as session information is passed through the connection 91a.

The connection 91a also transmits control channel commands that are not intended for view but rather for peer to peer (p2p) communications and remote access, as known in the art.

The control channel commands vary according to the specific features and applications that are included in the system implemented on the server 94.

The control channel commands may also be used to provide a real-time connection between two computer applications that use the present system as a connectivity method.

For example, the control channel commands may be used for games, support, presentation, training and many other computer applications.

Consequently, a new method for screen sharing is provided.

The new method may help overcome difficulties experienced through traditional screen sharing, when the two parties use different screens or different operating system set resolutions.

For example, SVG (Scalable Vector Graphics) graphics, which may be displayed correctly in any resolution, do not appear nicely on screens shared using traditional screen sharing methods, if the two screens have different resolutions.

With the new screen sharing method, SVG images may be generated on both screens dynamically, with viewing parameters optimized for each of the two screens. That is to say that the computer application which runs on the owner's computer synchronizes with the computer application which runs on the visitor's computer, for presenting synchronized and identical SVG images to both the owner and the visitor.

Similarly, moving animations may be generated and presented synchronically, to the visitor and the owner, by the two computer applications.

The control channel commands further allow anonymous connectivity and application sharing, in which the application server 94 implemented system, is used as a mediator.

The connection 91a may also deliver availability status of the content owners from the application server 94. The visitor's client 91 and supporting scripts are downloaded through the connection 91a. The visitor client's 91 software and scripts may be located in various places, such as on the application server 94, on the website 93 or in another location on the network 92.

A connection 93a is used to deliver API commands and applications between the website 93 and the application server 94. These API's are responsible for user, account and content item registration, modification, statistics, etc., as described in further detail hereinbelow.

In some embodiments, several of the APIs work through connection 91a and communicate with the visitor's client 91, through a control channel of the connection 91a.

A connection 94a is used by the system implemented on the application server 94, to send SMS messages from the system to an SMS service, say to an SMS gateway 917. The format of the SMS messages dependents on the specific SMS gateway 917 used. There are many SMS gateways 917 available on the market, such as an SMS gateway available from Txtlocal ltd. The SMS messages may be generated using an API, which inserts standard Http POST or GET queries to the SMS gateway 917, as known in the art.

A connection 94b is used by the system implemented on the application server 94, to sends connection instructions from the application server 94 to a VoIP gateway 918 or another voice service 918. The format of the connection instructions may dependent on the specific VoIP gateway 918 or other service chosen. For example, VoIP gateway specifications are available from Skype™, and other VoIP telephony services, as know in the art.

The connection 94c handles communication messages from the application server 94 (i.e. from the system implemented thereon) to instant messaging networks 919 such as Skype™ or Google™ Talk. The communications messages may include, but are not limited to: chat, availability status, voice, video, etc.

The messages' format dependents on specification provided by the instant messaging network 919 in use. For example, Google Inc. provides Google™ Talk specifications on Google's website.

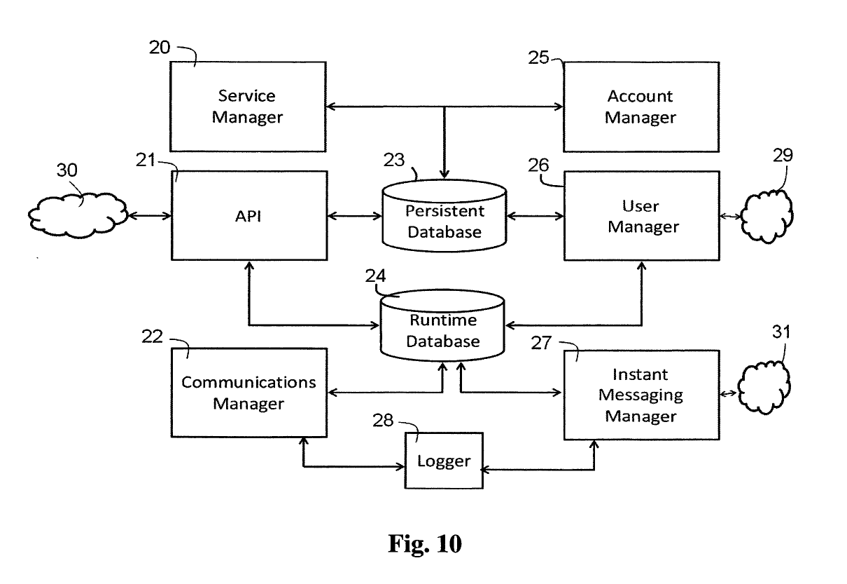

Reference is now made to FIG. 10, which is a block diagram schematically illustrating a seventh exemplary system, for communication in context of content, according to an exemplary embodiment of the present invention.

A seventh exemplary system is implemented on a server computer, in which most of the components of the seventh system are deployed, and on a client agent.

Optionally, the client agent is a computer program installed on a visitor's computer. Alternatively, the client agent is a software module, which works from the visitor's web browser, as known in the art.

Since the seventh system is software based, the parts of the system may be arranged in different order, combined, split, etc. Further, in some embodiments, one or more of the parts may be absent from the system. Furthermore, in some embodiments, the seventh system may use different computer networks, as described in further detail hereinbelow.

The seventh system includes a service manager 20.

This services manager 20 manages one or more services presented to a visitor as content items on one or more web pages, as described in further detail hereinbelow.

For example, the service manager 20 manages the names of the content items, and the owners assigned to each of the content items.

The service manager 20 further manages availability rules and permissions for each of the owners, and monitors the overall availability for each specific one of the content items.

The overall availability is a combination of the availability of each of the owners assigned to the content item, through different communication methods. The overall availability may be pre-defined per content item or per owner, say by an authorized administrator of the seventh exemplary system.

The seventh system further includes an API (Application Program Interface) Manager 21.

The API Manager 21 provides a set of commands, which allows a user of the system (say a customer, as described hereinbelow), to configure and influence the operation of other parts of the system.

The API Manager 21 may use several groups of APIs, as known in the art.

The API Manager 21 may use a group of operational APIs, which provides an interface which allows a user (say one of the content owners) to configure and use the content item.

The operational APIs may include, but are not limited to: Availability APIs—for monitoring availability of owners through communication methods, Account APIs—for updating user account data, Content APIs—for configuring and operating content items, and User APIs—for defining user parameters (say parameters of an owner and assignment of one or more owners to a content item).

The API Manager 21 may further use a group of customization API's, which provides an interface which allows a user (say a system administrator) to customize the system. The customization APIs may include, but are not limited to: a client interface design API—say for designing a client user interface, an API for presenting availability status to a visitor, etc.

The API Manager 21 may further use a group of monitoring APIs, such as an API for generating or retrieving system usage statistics, an API for archiving or retrieving archived data, or an API for monitoring the system in real time.

The API Manager 21 communicates with websites and computer programs deployed on computers remote from the computer server of the seventh system, through networks 30 such the internet, an organizational intranet network, or another network, as known in the art.

The API Manager 21 provides the websites and computer programs on the remote computers, with the ability to set, configure and monitor owners, content items, etc. Permissions to access specific commands of the API Manager 21 may be limited by access control rules, set by an administrator of the seventh system, etc., as known in the art.

The API Manager 21 may communicate with each of the seventh system's parts, as well as with the computer programs and websites on the remote computers, through the internet, an intranet network, a local network, etc., as known in the art.

The seventh system further includes one of the communication data selectors 110, 220, 230 and one of the communication channel establisher 230, 330, as described in further detail hereinabove.

In the exemplary method illustrated using FIG. 10, the communication data selector and the communication channel establisher are implemented as a single module 22, also referenced hereinbelow as a communications manager 22.

The communications manager 22 is further used as an interaction data receiver 110, 210 or 310, as described in further detail hereinabove.

When the communication manager 22 receives data, which indicates that a visitor interacts with a content item, the communications manager 22 opens a virtual chat-room for the visitor and the owners of the content, to communicate through.

In order to open the chat-room, the communications manager 22 selects one or more owners amongst owners pre-assigned to the content item and available for communication. Optionally, the communication manager 22 selects the owner according to a criterion based on availability of the owner through communication methods pre-assigned to the owner, as described in further detail hereinabove.

The communications manager 22 further selects a communication method for each of the owners, amongst the communication methods pre-assigned to the selected owner, as described in further detail hereinbelow.

Then, the communications manager 22 establishes a communication channel between the visitor and each of the selected owners, through the selected communication method.

By establishing the communication channels between the visitor and the selected owners, the communications manager 22 opens the virtual chat-room for the visitor and the selected owners to communicate through.

Optionally, the communication channels established by the communications manager 22 connect more than one visitor to more than one owner.

For example, the chat-room may include communication channels established for different visitors and owners of the same content item, for different visitors that interact with different content items of the same owner, etc., as described in further detail hereinbelow.

The communications manager 22 may communicate with the visitor through a graphical user interface, such as a communication window similar to communication windows implemented in chat rooms on the web, as known in the art.

The visitor may be allowed to close the communication window. When the visitor closes the window, the communications manager 22 closes the chat-room, by closing the communications channels.

Optionally, the communications manager 22 further includes the message enhancer, which enhances messages transmitted through the communication channels established by the communication manager, as described in further detail hereinbelow.

For example, the communications manager 22 may monitor a chat in one of the communication channels, log the chat and store the chat transcript.

The message enhancer may further enhance messages transmitted through the communication channels, say by communicating with additional message processing units (not shown).

The enhancement of the messages may include, but is not limited to: real-time translation, message monitoring (say for abusive behavior), machine learning that takes answers and automatically stores answers as FAQ (Frequently Asked Questions) data, owner typing assistance with pre-defined answers, message monitoring for obtaining commercial information about the chat content, etc., as described in further detail hereinbelow.

The seventh exemplary system further includes a persistence database 23.

The persistence database 23 may be used by the service manager 20, API Manager 21 and other parts of the system. The persistence database 23 holds information about the system settings, content item settings, owner settings, etc. The persistence database 23 may store usage and performance statistics, archived messages, etc, as known in the art.

The seventh exemplary system further includes a runtime database 24.

The runtime database 24 stores real time statuses of communication channels, availability of each specific one of the owners through different communication methods assigned to the specific owner, and overall availability per content item, as described in further detail hereinabove.

The seventh exemplary system further includes an account manager 25.

In an exemplary embodiment of the present invention, customers are assigned accounts. Each of the customers has an account. The customer may be a website which presented several content items (say ads with a clickable button next to each of the ads), a small customer with a single content item presented on several web sites, a customer with a single content item presented on a single web page, etc.

The customer may use the API Manager 21, to communicate with the content owner assigner, for assigning one or more owner(s) to each of the customer's content item, as described in further detail hereinabove.

The customer may further use the API Manager 21, to communicate with the owner communication method assigner, to define one or more communication methods for an owner, as described in further detail hereinabove.

Using the API Manager 21, the customer may define his owners, communication channels for the owner, one or more criterion for selecting an owner to communicate with a visitor, such as availability time schedules (which define for each owner a time table of availability), define priority among different owners assigned to a content item, etc.

Using the API Manager 21, the customer may further register content items to his account, define billing data, set a look and feel of clickable buttons positioned next to content items on web sites or of the content items, define monitoring tasks for the system to carry out, etc., as described in further detail hereinbelow.

The account manager 25 manages the customers and links the customer accounts to contents, owners, statistics and billing, and is configurable by the customer, through the API Manager 21, as described in further detail hereinbelow.

The customer may communicate with the API Manager 21, through a computer network 30 (say the internet or an intranet network).

The seventh exemplary system further includes a user manager 26.

The user manager 26 handles users that are active on line, say a customer who is logged in to the system, using a computer network 29, as described in further detail hereinbelow.

The user manager 26 further keep records of users not logged in, say content owners and website visitors. The user manager 26 manages user authentication, registration and availability status and rules, as described in further detail hereinbelow.

The user manager 26 manages the users and allows users to view and modify account settings, based on user authorization data, using the API Manager 21.

The seventh exemplary system further includes an instant messaging manager 27.

The instant messaging manager 27 monitors the availability of the owners through the owners' instant messenger services (such as Skype™).

The instant messaging manager 27 manages an interface to the different instant messaging services, which may constitute some of the communication methods of the owners, as described in further detail hereinbelow.

The instant messaging manager 27 communicates with a server of the instant messaging service, through a computer network 31, say through the internet or through an enterprise intranet network.

The system may further include a logger 28.

The logger 28 logs or records communication session data, say time in which a certain owner communicates with a visitor who interacts the owner's content item, time in which a certain content item is clicked on by a visitor, etc.

Optionally, the logger 28 also archives messages in a chat archive database.

The messages archived may include, but are not limited to: chat transcripts, textual messages, audio-visual recordings, SMS messages, data forms filled up by visitors, etc., as described in further detail hereinbelow.

The computer networks 29-31 may be the same network, such as the Internet, or a combination of networks.

Different parts of the system may communicate among themselves.

For example, the account manager 25 may communicate with the user manager 26, but usually, the account manager 25 communicates with the persistent database 23.

By contrast, the API Manager 21 is likely to communicate with any of the parts of the system, say for conveying instructions from customers, as described in further detail hereinbelow.

Communications between the account manager 25 and the persistent database 23 may include, but are not limited to: account administration information, billing settings, account usage plan, usage statistics and account changes log.

Communications between the API Manager 21 and the persistent database 23 may include, but are not limited to: data about the services, data about accounts and owners, etc.

The API Manager 21 exposes internal properties and values to authorized users, such as a customer who has an authorized account, as described in further detail hereinbelow.

Communications between the user manager 26 and the persistent database 23 may include, but are not limited to: information about users, user authorizations, communication methods, availability schedules, rules, nicknames, preferences, etc., as described in further detail hereinbelow.

Communications between the user manager 26 and the runtime database 24 may include, but are not limited to: real time availability information, user presence in active chat-rooms, etc.

Communications between the service manager 20 and the runtime database 24 may include, but are not limited to: real time user availability, content availability information, user presence in chat-rooms, etc.

Communications between the API Manager 21 and the runtime database 24, may include, but are not limited to real time availability status of users (say customers or owners) and content items, as described in further detail hereinbelow.

Communications between the communications manager 22 and the runtime database 24, may include, but are not limited to: creation and closure of chat-rooms, user allocation to active chat-rooms, etc.

Communications between the communications manager 22 and the user manager 26 may include, but are not limited to messages that arrive from the visitor. The message from the visitor may be distributed through the communications to various owners. Each owner receives the message through a communication method, the owner is available through.

Communications between the instant messaging manager 27 and the runtime database 24 may include, but are not limited to availability of instant messaging users and roster updates, say XMPP rosters. An XMPP Roster is a contact list in the Instant Messaging Protocol (XMPP), as known in the art.

Communications between the communications manager 22 and the instant messaging manager 27 may include but are not limited to messages that arrive from the visitor and are distributed to owners. Optionally, the messages are distributed to the owners through one or more instant messaging (IM) service based communication method(s) that the owners are available through, say through Skype™ or ICQ™.

The Communications between the communications manager 22 and the instant messaging manager 27 may include textual messages (say text chat messages), audio, video, etc.

Communications between the API Manager 21 and a computer network 30 (say the internet) may be based on simple HTTP based APIs, in XML (Xtensible Markup Language) format or a similar format, as know in the art.

Communications between the user manager 26 and a computer network 29 (say the internet) may be XHTML (eXtensible HyperText Markup Language) based, as known in the art.

Communications between the instant messaging manger 27 and various instant messaging services is likely to be specific to each instant messaging (IM) service in use by the owners, and be based on each IM service's specific protocol.

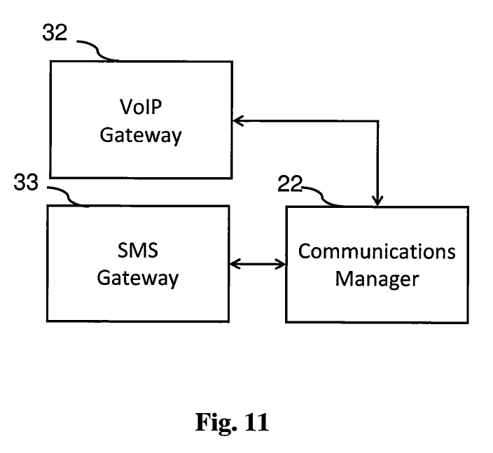

Reference is now made to FIG. 11, which is a block diagram schematically illustrating an eighth exemplary system, for communication in context of content, according to an exemplary embodiment of the present invention.

A system according to an exemplary embodiment of the present invention includes the communication manager 22, as well as all remaining parts of the seventh system, as described in further detail hereinabove, and illustrated using FIG. 10.

In the exemplary system illustrated using FIG. 11, when a visitor clicks on a content item, availability rules or a specific content owner's availability status, may prevent establishment of a communication channel for direct conversation (or chat) between the visitor and a certain owner.

However, the communications manager 22 may still select the specific owner, and send an SMS message directly to the mobile phone of the owner, by sending a string through an SMS gateway 33.

There are many SMS gateways 33 currently in use, such as an SMS gateway 33 available from Txtlocal ltd. The SMS messages may be generated using an API program, which inserts standard Http POST or GET queries to the SMS gateway 33, as known in the art.

The exact format of the string, the communications manager 22 sends to the SMS gateway 33 may dependent on the specific SMS gateway 33 in use.

Optionally, the communications manager 22 rather establishes a telephone connection between the owner and the visitor, through a VoIP (Voice over Internet Protocol) gateway 32. VoIP gateway specifications are available from a variety of telephony services, such as Skype™, as know in the art.

The exact format of instructions, the communications manager 22 sends to the VoIP gateway 32 may dependent on the specific VoIP gateway 32 in use.

Optionally, the logger 28 (see in FIG. 10) records usage and costs of each call or SMS, and adds the costs to a bill of account managed by the account manager 25, as described in further detail hereinbelow.

The logger 28 may also store the SMS string in an archive, on the persistent database 23, as described in further detail hereinbelow.

Optionally, the logger 28 further records the VoIP calls in an archive, on the persistent database 23, as described in further detail hereinbelow.

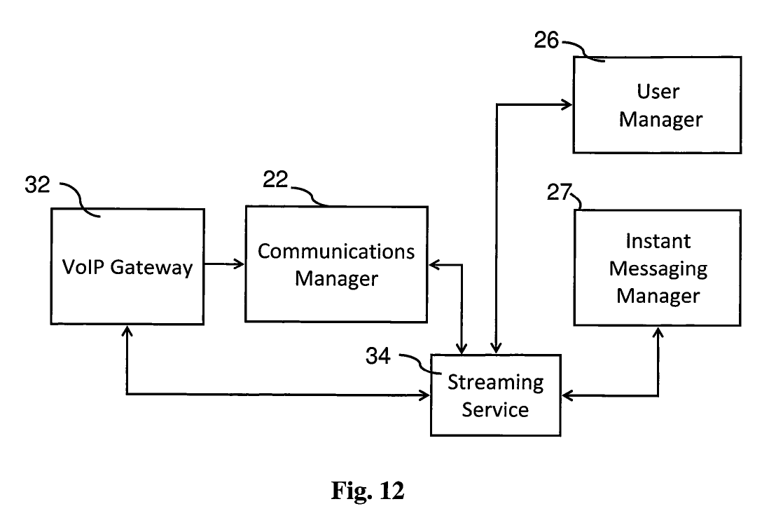

Reference is now made to FIG. 12, which is a block diagram schematically illustrating a ninth exemplary system, for communication in context of content, according to an exemplary embodiment of the present invention.

A system according to an exemplary embodiment of the present invention includes the communication manager 22, the instant messaging manager 27, the user manager 26, and all remaining parts of the seventh system, as described in further detail hereinabove, and illustrated using FIG. 10.

The exemplary system illustrated using FIG. 12, allows voice and video communications between the visitor and the owner, say through a window-like graphical user interface implemented on the webpage visited by the visitor. The window-like graphical user interface presents images delivered through Flash technology, HTML5, etc., as known in the art.

Optionally, the visitor hears the audio through a phone call delivered using the VoIP gateway 32 or using an audio streamed to the visitor's computer, as described in further detail hereinabove.

Optionally, the communication manager 22 streams the owner's voice through the VoIP gateway 32, to the window-like graphical user interface implemented on the website visited by the visitor, as described in further detail hereinabove.

Optionally, the communication manager 22 captures the owner's voice and video, from the owner's instant messaging client, using the instant messaging manager 27.

The instant messaging manager 27 connects to video and audio APIs of an instant messaging service used by the owner. The instant messaging manager 27 forwards audio and video packets transmitted by the instant messaging service, to a video streaming service 34.

Two of many exemplary video streaming services known in the art, are Adobe™ FMS (Flash Media Server) and Wowza™ Streaming Server.

The video streaming service 34 converts the audio and video packets into a format usable for streaming into the window-like graphical user interface and back.

Optionally, the video streaming service 34 further streams the converted packets through the VoIP gateway 32, to the visitor's phone, say using SIP (Session Initiation Protocol (, as known in the art.

Exemplary APIs that the video streaming service 34 may use for converting the packets, include, but are not limited to Google™ Phone APIs available on Google's Jingle library, etc., as known in the art.

The video streaming service 34 may use one of the protocols known in the art.

For example, Adobe™ FMS uses Real Time Messaging Protocol (RTMP).

RTMP is a protocol suitable for streaming audio, video and data over the Internet, between a Flash player and a computer server.

The RTMP protocol has three variations.

The first variation is a plain protocol, which works on top of TCP (Transmission Control Protocol) and uses TCP port number 1935, as known in the art.

The second variation, also known as RTMPT, is encapsulated within HTTP requests, to traverse firewalls, as known in the art.

The third version, also known as RTMPS, is implemented over a secure HTTPS connection, as known in the art.

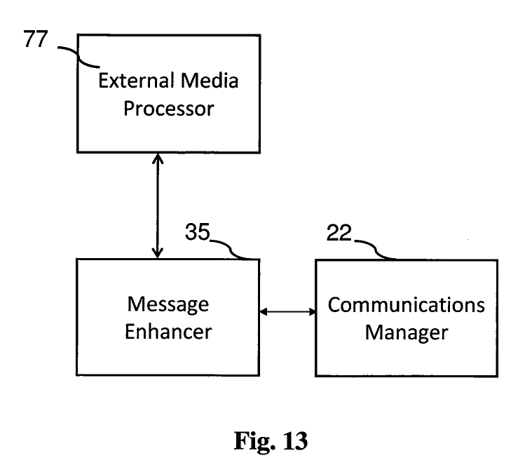

Reference is now made to FIG. 13, which is a block diagram schematically illustrating a tenth exemplary system, for communication in context of content, according to an exemplary embodiment of the present invention.

A system according to an exemplary embodiment of the present invention includes a message enhancer 35, as well as the communication manager 22 and all remaining parts of the seventh system, as described in further detail hereinabove, and illustrated using FIG. 10.

The message enhancer 35 listens and intercepts communications between the visitor and the content owners, and enhances the intercepted messages.

The message enhancer may further extract and collect predefined data from a communication channel between the visitor and the selected owner.

The enhancement of the intercepted messages may include, but is not limited to:
Detection of keywords in chat or voice messages, such as detection of abusive or illegal activity, detection of important information (say for archiving).
Correction of spelling.
Real time machine translation, which allows the visitor and the owner to communicate in different languages.
Technical quality monitoring of audio and video communications.
Natural language processing, say for automatic or semi-automatic building of a FAQ (Frequently Asked Questions) database, from answers given by content owners to visitors, as described in further detail hereinbelow.
Detecting commercial trends, by analysis of many discussions between visitors and owners. The topic trends can also provide valuable information for the advertising engine, which can match ads which are relevant to the content of the chat.
Voice and video analysis. Current technologies detect a visitor who lies from the tone of the visitor's voice or from the visitor's body language. There are also technologies to analyze a visitor's personality according to the visitor's image or video stream, say technologies provide by Profiler1 Ltd. Voice and video analysis through a system according to an exemplary embodiment of the present invention, may also prove useful for ecommerce websites, classifies ads websites, dating websites, job searching websites, etc.
Auto complete, and answer assistance, by offering an owner answers to questions previously asked by visitors, to use when the owner chats with a visitor, etc.
Gesture detection in video. Gesture detection may be used for various behavioral information retrieval and even for games between the visitor and content owner, as known in the art.
Interpretation of commands. For example, when a content owner types or says a certain command, the visitor's window may be affected accordingly (say by forwarding the visitor to a purchasing window).
Voice transcript. Using machine voice recognition technologies such as the technology provide by Nuance™ Inc., voice may be automatically converted to text. The text may be sent to the content owner and in some cases also to the visitor. Since the visitor's voice stream is separate from the content owner's voice stream, it is possible to identify who says a sentence, and with the voice recognition, to convert to said sentence to text.

Optionally, the message enhancer 35 further communicates with one or more external media processor(s) 77 of a third party, for carrying out one or more processes enhancing of the messages intercepted, using a machine voice recognition service offered by the third party.

For example, the message enhancer 35 may communicate with Google™ Translate (Google's machine translation service).

Optionally, the type of message enhancement carried out by the message enhancer 35 depends on account settings, service settings, user settings or by a specific request by a visitor or a content owner during the initiation of a chat or in the middle of a chat.

Optionally, the message enhancer 35 further post-processes messages in a batch mode, by processing messages previously recorded and archived (say on the persistence database 23, as described in further detail hereinabove).

Optionally, the message enhancer 35 may be operated by an administrator or a content owner, for adding questions and answers to a FAQ database.

In one example the message enhancer 35 allows the owner to manually edit questions and answers from a webpage or from a client program implemented on the owner's computer.

In a second example, the message enhancer 35 allows the owner mark a section in a textual chat discussion, in which a visitor asks a question and the owner answers, thus allowing the owner to select the question and answer for the FAQ database.

In a third example, the message enhancer 35 automatically detects questions and answers in a chat between the visitor and the owner, and rearranges the questions and respective answers according to frequency. Then, the message enhancer 35 adds a number of most frequent asked questions and answers to the FAQ database, say the ten most frequently asked questions among the questioned rearranged by the message enhancer 35.

Optionally, questions and answers from the FAQ database are presented to the owner (say in a chat window) in a list, and the owner is allowed to select answers from the list, by a copy and paste operation, as known in the art.

Optionally, the message enhancer 35 further allows the owner to assign a short code to an answer in the FAQ Database. When the owner uses the short code in a message, the message enhancer 35 enhances the message, by automatically replacing the short code with the answer.

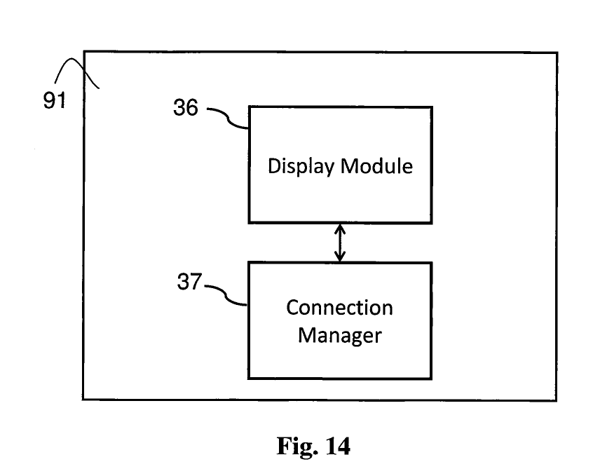

Reference is now made to FIG. 14, which is a block diagram schematically illustrating a first client agent, for communication in context of content, according to an exemplary embodiment of the present invention.

In one exemplary embodiment, the client agent 91 is implemented as a part of the content item itself.

For example, the client agent 91 may be a part of a flash movie inserted into a webpage and presented to a visitor who visits the webpage when the flash movie is presented on the webpage.

The client agent 91 includes a display module 36.

The display module displays chat messages, video, voice, etc., to a visitor, through the window.

The client agent 91 further includes a connection manager 37 in communication with the display module 36.

The connection manager 37 connects the visitor with the system 4 implemented on the computer server, as described in further detail hereinabove.

Optionally, the Flash movie (the client agent 91 is a part of) is inserted into a banner, which is used as a content item for advertising in several web pages, in different time frames. The insertion of a flash movie and computer code of the client agent 91 to the banner may be carried out using tools like Acrobat™ Flash, as known in the art.

If no content owner assigned to the banner (i.e. the content item of the example) is available online, the banner shows a video clip.

However, if one of the content owners is available, an ad displayed to the visitor, invites the visitor to click on the banner, for directly communicating with the content owner.

Upon clicking, the communication manager 22 establishes a communication channel between the owner and the visitor, and video images or textual messages of the owner are inserted into the banner and presented to the visitor. That is to say that the owner and the visitor chat directly through the banner itself.

Using the client agent 91, which integrates communications in the Flash movie displayed directly on the banner, live interaction between content owners and visitors may be linked directly to the dynamic content (say the banner), which may be placed on any web site.

For example, banner exchange systems may rotate banners among several web sites, thus rotating the client agent itself 91 among the web sites, and allowing the user to communicate with visitors on various websites.

That is to say that the computer code of the client agent 91 of the present exemplary embodiment, is not a part of a specific web site's code, but is rather embedded into the Flash movie of the advertisement. Consequently, live interaction with the banner's viewers (i.e. visitors) is available on any website the visitors visit when the banner is presented on the website visited.

The embedding of the client in a Flash movie may also add connectivity to various applications, from games, to social networks, videos, widgets, web templates, etc.

Optionally, HTML5, which includes voice and video features, may serve as an alternative to Flash technology, for embedding the client agent 91 into the content item (say the banner of the present exemplary embodiment).

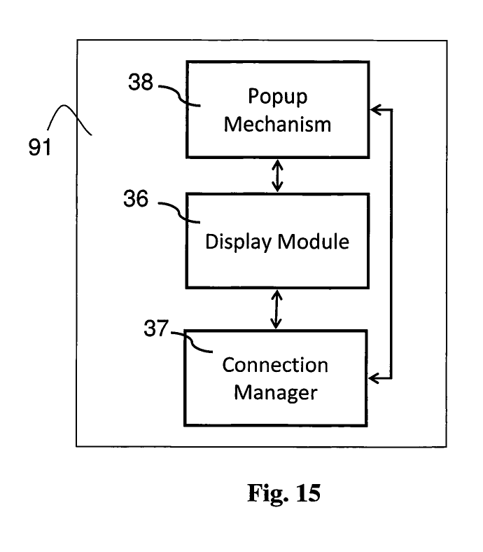

Reference is now made to FIG. 15, which is a block diagram schematically illustrating a second client agent, for communication in context of content, according to an exemplary embodiment of the present invention.

In one exemplary embodiment of the present invention, the client agent 91 is rather implemented by placing computer code in a specific web page. The code may consist of a combination of several technologies. The combination may include, but is not limited to technologies such as html, html5, CSS, Java script, DHTML, Ajax, Java applet, Flash, etc., as known in the art.

The client agent 91 includes a display module 36.

The display module 36 displays chat messages, video, voice etc., to a visitor, through a window on the specific web page, as described in further detail hereinabove.

The client agent 91 further includes a connection manager 37 in communication with the display module 36.

The connection manager 37 connects the visitor with the system 4 implemented on the computer server, as described in further detail hereinabove.

The client agent 91 of the present embodiment further includes a Popup Overlay Mechanism 38.

The Popup Overlay Mechanism 38 manages popping up of the window on the webpage. The window allows the visitor to interact with an owner through a variety of communication methods, as described in further detail hereinbelow.

The Popup Overlay Mechanism 38 may be based on a standard Java script code for in-page or external window popup, as known in the art.

Exemplary pop-up Java scripts are available from JQuery Project, PWC—Prototype Window Class, and the Dojo Foundation (Dojo Toolkit), say on their web sites, as known in the art.

The popup overlay mechanism 38 is in communication with the connection manager 37.

When a visitor invokes the popup window (say by clicking on a content item), the popup overlay mechanism 38 notifies the communication manager 37, which in turn, establishes a connection with the system 4 implemented on the application server 4, as described in further detail hereinabove.

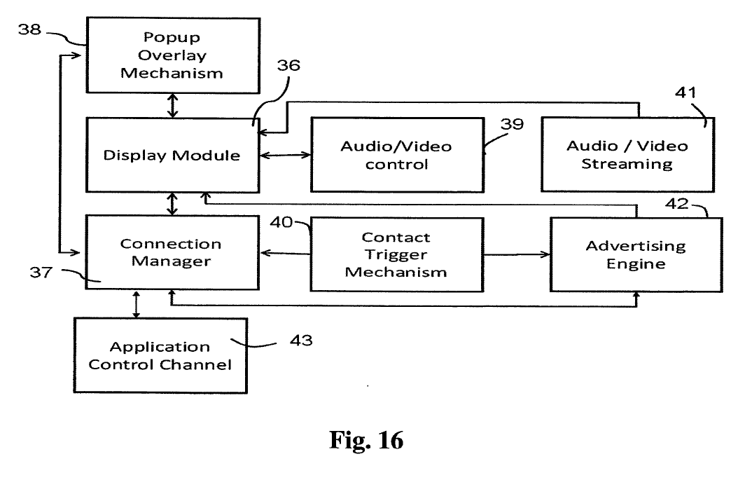

Reference is now made to FIG. 16, which is a block diagram schematically illustrating a third client agent, for communication in context of content, according to an exemplary embodiment of the present invention.

The client agent according to an exemplary embodiment of the present invention includes the pop up overlay mechanism 38, display module 36 and connection manager 37, as described in further detail hereinabove.

The client agent according to present exemplary embodiment of the present invention further includes a contact trigger mechanism 40.

The contact trigger mechanism 40 pro-actively triggers a connection with a website visitor.

Optionally, an administrator, a customer, or a content owner defines the rules and criteria which the contact trigger mechanism 40 uses to trigger the connection.

Some non-limiting examples for possible rules and criteria include inviting the visitor to chat upon one of the following events:
The visitor views the content item for more than one minute.
The visitor navigates away from the web page.
The visitor focuses on a certain area of a web page, such as a promotional area. The location of visitor's focus may be determined by visible DOM (Document Object Mode) Elements, as known in the art.
The same visitor re-visits the content item. For example, a cookie on the visitor's computer may indicate the number of times the user visits a certain webpage the content item is placed on.
The visitor comes from a specific geographical region. Optionally, the visitor's IP address is detected using IP location data, or using GPS information available on certain cellular devices.

For example, the visitor's prior activities may indicate that he may be a serious potential customer. Such prior activities may be documented as cookies saved on the visitor's device. The cookies may indicate the number of chats the client has on a certain topic, history of purchases, etc.

The information may extend beyond a specific webpage (say a shopping cart webpage of a shopping website), or website, and include any webpage which uses the system and is visited by the visitor.

For example, in an e-commerce website, if a visitor abandons a shopping cart web page, the next time the visitor visits the web page, the contact trigger mechanism 40 offers a chat proactively.

In shopping web sites and other web sites, the contact trigger mechanism 40 may offer the visitor special offers, etc., as known in the art.

The allocation of an available operator or multiple operators to a visitor is done according to pre-defined rules. The criteria can be different between owners, and communication methods. Some of the examples for such criteria are:
If the owner is online, then the system may provide a visual and audio notification after a visitor views the content for more than ten seconds.
When the owner is offline, say in the afternoon, the owner may be called at his home phone or mobile phone, with a single ring (to avoid charges from the phone companies). The owner may see a caller identification number that corresponds to the website, and expect a call.
At certain times, such as late at night, the visitor may be allowed to leave a message to the owner.
If the visitor's IP address comes from a foreign country, the system may prioritize owners who speak the relevant language or are responsible for the geographical area of the foreign country.
If a visitor has a web-camera and wants to have a video conversation, the system may prioritize an available owner who also has a web-camera.
The system may also prioritize owners, according cost of the owner's communication methods. For example, Internet communications may be cheaper than cellular or land phone lines.

The client agent further includes an audio and video control module 39, which controls audio and video chats. The audio and video control module 39 may further connect to the visitor's microphone and webcam.

Audio and video connections may require security approval from the visitor's operating system, browser or other programs. The video control module 39 also handles security requirements to make such connections possible.

The client server of the present embodiment further includes an audio and video streaming module 41, which communicates with the display module 36.

The audio and video streaming module 41 further communicates with the video streaming service 34 implemented as a part of system 4 on the remote server, say on an application server, as described in further detail hereinabove.

The display module 36 receives voice and video message streams from the audio and video streaming module 41, and presents the streamed audio and video messages to the visitor, under the control of the audio and video control module 39.

The connection manager 37 communicates with the system 4 implemented on the application server, as described in further detail hereinabove.

The connection manager 37 receives from the system incoming chat messages, and dispatches outgoing messages. Optionally, the messages are transmitted as XML packets. The XML packet may further include control channel commands formatted as XML with a special tag names or attributes, as known in the art.

The control channel commands vary according to the specific features and applications that are included in the system. Formats other than XML are also possible. For example: CSV, JSON, AMF binary, etc, as known in the art

Optionally, the client agent of the present embodiment further includes an application control channel module 43.

The application control channel module 43 provides a real-time connection between third party applications that use the client agent and the system on the application server 4, as a platform for connectivity between computer applications that run on separate computers.

Each of the computer applications communicates with the system implemented on the server 4, using a client agent of the present embodiment.

The application control channel module 43 communicates with the computer applications using APIs.

That is to say that the system implemented on the application server 4 and the client agents mediate between the two third-party computer applications, and transmits API data between the two third party applications.

Consequently, a system according to an exemplary embodiment of the present invention, may overcome some short comings of traditional screen sharing methods, in which the two parties (say users of two remote computers) have different screen or window resolutions, as described in further detail hereinabove.

Since a direct control channel is opened, both computers may have the same application run simultaneously, and the two applications may be synchronized using the client agents and the system of the exemplary embodiments, as opposed to traditional screen sharing that just shows an image of another user's screen.

Optionally, the system of the present embodiments allows simple, anonymous connectivity and application sharing. This is opposed to solutions that require both users to authenticate and log into a secure system.

One example for screen sharing, involves synchronization between a web browser of a sales person and a web browser of a customer. Consequently, the sales person may show the customer around different pages and websites, while controlling the content that the customer views.

Another examples are online gaming and meeting scheduling.

With traditional online games, both players need to first connect to a gaming server, and only then, can the two players play together. With an exemplary embodiment of the present invention, a player can alert his friend through any type of communications, and then, when the friend launches his game application, both game instances are connected through the agents 91 and system 4.

One example involves a scheduling system, such as Microsoft™ Exchange Server.

With the present embodiments, when a meeting schedule is modified by an organizer, notification to all the participants of this meeting, through a variety of communication methods (say to a variety of networks), is distributed through the client agents 91 and the system on the application server 4. Further, the organizer, or the Microsoft™ Exchange server, may receive textual or verbal replies from participants.

In some cases, advertising is provided in chat windows.

Advertising in chat windows may prove useful, especially for larger websites and may assist in financing the chat costs and in revenue-sharing profits, as known in the art.

Optionally, the client agent further includes an advertising engine 42, in communication with the display module 36 and the connection manager 37.

The advertising engine 42 may inserts textual ads, graphical ads and movies in the visitor's client window, through the display module 36.

The advertising engine 42 further uses the API Manger 21 (described in further detail hereinabove), to retrieve data about a content item that the visitor interacts with.

The advertising engine 42 forwards the data about the content item to advertising networks, such as Google™ Adsense or banner exchange networks, through the connection manager 37. Consequently, the advertising networks may present relevant ads to the advertising engine 42.

Optionally, the advertising engine 42 communicates with the contact trigger mechanism 40, for retrieving more knowledge about the visitor, for more intelligent advertising.

In one example, the advertising engine 42 retrieves data which indicates that the visitor views content related to cars, while the content trigger mechanism 40 recognizes that the visitor is in a specific town.

Consequently, the advertising network sends an ad of a car dealer located in the visitor's town to the advertising engine 42, which presents the ad to the visitor.

In another example, the advertising engine 42 delivers advertising which is suitable to the type of communication the visitor uses.

Exemplary types of advertising include, but are not limited to: Graphical ads (optionally, with animation effects), Advertising videos (similar to commercials on TV), Promotional games, Polls and Data entry forms.

The advertising videos may be synchronized with a textual chat. For example, when the visitor types a message, the video may be paused. This is because the visitor is now focused on typing and is not likely to pay attention to the promotional video. Once the visitor sends the message, the video continues while the visitor waits for the reply from the content owner. Once the reply arrives, the video pauses again, to allow the visitor to read the reply and answer. Promotion in games may be be synchronized in a similar manner.

Text and graphical ads may change for every message. Assuming that the visitor views the ads during the time in which the content owner reads his message and types back a reply, ads may also be synchronized with the textual messages. For example, each time the visitor types a message, the ads may be replaced with new ads. Consequently, the visitor is exposed to multiple ads during a single chat, provided all ads presented get effective visibility time.

Polls and Data entry forms may be synchronized to messages, or rotated only once the visitor casts a vote (or fills up a form). Polls and Data entry forms may also be posed as a requirement for a visitor to fill up before the visitor is allowed to access another feature. For example, the visitor may be required to fill out a contact form before the visitor is allowed to chat or shift to a voice or video call.

Optionally, the message enhancer 35 further listens to a chat between a visitor and a content owner, be the chat textual, audio or video. Then, the message enhancer 35 matches relevant ads to the keywords that are detected during the chat. Ad matching may also take into account the location of the visitor, according to IP address, a mobile phone's GPS (Global Positioning System), mobile tower positioning, etc, as known in the art.

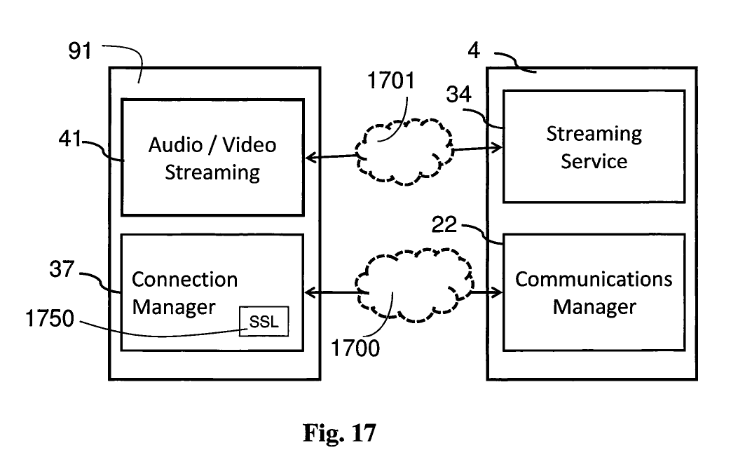

Reference is now made to FIG. 17, which is a block diagram schematically illustrating a fourth client agent, for communication in context of content, according to an exemplary embodiment of the present invention.

A client agent 91, according to an exemplary embodiment of the present invention includes the connection manager 37, the audio and video streaming module 41, and other parts, as described in further detail hereinabove.

The connection manager 37 communicates with the communication manager 22 of system 4, through a computer network 1700. The computer network 1700 may be the Internet, an Intranet, etc, as known in the art.

Optionally, the communications are protected by encryption.

The connection manager 37 may include an SSL module 1750. The SSL module 1750 provides SSL protocol services to the connection manager 37, thus allowing the connection manager 37 to communicate with the communication manager 22 over a standard SSL connection, or through any known in the art security mechanisms.

The audio and video streaming module 41 communicates with the streaming service 34 of system 4, through a computer network 1701. The computer network 1701 may be the Internet, an Intranet, etc., as known in the art.

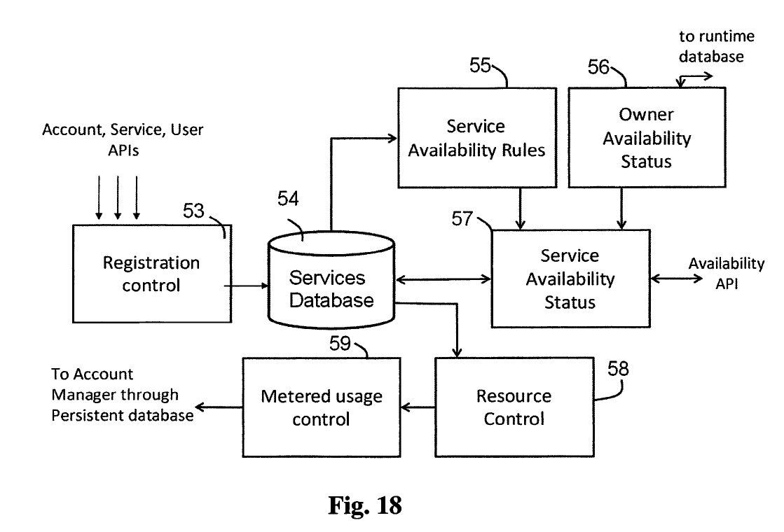

Reference is now made to FIG. 18, which is a block diagram schematically illustrating a service manager for communication in context of content, according to an exemplary embodiment of the present invention.

The service manager 20, as described in further detail hereinabove, may include a registration control 53.

The registration control 53 registers the content items in a services database 54. The registration control 53 registers the content item as a service data record. The service data record defines the content item by a set of parameters. Consequently owners may be assigned to the content item.

Each content item belongs to a specific account defined using the account manager 25, as described in further detail hereinabove.

Optionally, the services database 54 is implemented on the persistent database 23 and the runtime database 24, as described in further detail hereinabove. More specifically, content availability information is stored in the runtime database 24 and other information and settings are stored in the persistent database 23.

The service manager 20 further includes a service availability rules module 55, in communication with the services database 54.

The service availability rules module 55 determines if a content item (say a content item used to offer a service or product) is available. Examples for such rules include, but are not limited to:
When any instant messenger user, which belongs to one of the owners of the content items, is available and not engaged in communication in another chat-room.
When any socket user is available.
At specific hours, in which the service offered through the content item is scheduled to be available at.
Geographical location of the visitor and the available owners. For example, North American visitors may see the service if a North America sales agent (i.e. owner) is available on line.
Owners are not available through the owners' instant messaging service clients but are available through SMS or Phone.
If the owners are not available the service is still available. However, the service manager 20 connects a visitor to an external call center or an automatic answering service.

The service manager 20 further includes an owner availability status module 56.

The owner availability status module 56 determines an owner's availability on the owner's instant messaging service's client (which is a socket connection example), according to data read from the runtime database 24, as described in further detail hereinabove.

The service manager 20 further includes a service availability status module 57.

The service availability status module 57 combines content availability data provided by the service availability rules module 55 with the owner availability data provided by the owner availability status module 56.

Optionally, the service availability status module 57 generates one or more availability indications in a Boolean form (true/false), such as: Text chat available, SMS available, phone connections available, video not available, voice not available, etc.

The service manager 20 further includes a resource control module 58.

The resource control module 58 allocates and releases owners to (and from) chat rooms, based on owner availability status received from the services database 54, as described in further detail hereinbelow.

For example, the resource control module 58 may receive the owner availability data from the runtime database 24 (a part of the services database 54 is implemented on), as described in further detail hereinabove.

The service manager 20 further includes a metered usage module 59, in communication with the resource control module 58.

The metered usage module 59 monitors and records usage data of services such as SMS, PSTN, chats, VoIP calls, Video, etc., as described in further detail hereinabove.

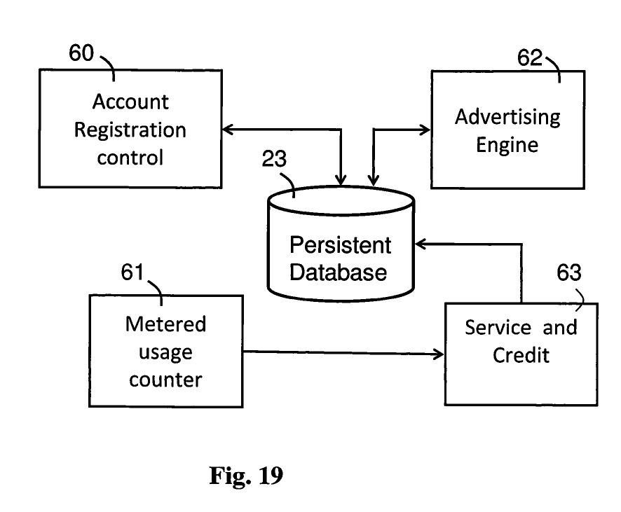

Reference is now made to FIG. 19, which is a block diagram schematically illustrating an account manager, for communication in context of content, according to an exemplary embodiment of the present invention.

The account manager 25, as described in further detail hereinabove, may include a registration control module 60.

The registration control module 60 registers accounts, and assigns content items to the account, based on user commands (say commands of an owner or an account manager), delivered to the registration control module 60 from the API manager 21, as described in further detail hereinabove.

The account manager 25 may further include a metered usage counter 61.

The metered usage counter 61 reads from the persistence database 23 usage data which originates from the metered usage control module 59 for content items, as describes in further detail hereinabove.

The metered usage counter 61 aggregates the usage data of the content items, for each account.

The account manager 25 may further include an advertising engine 62.

The advertising engine 62 inserts advertisements to specific content items.

The advertising engine 62 may schedule and synchronize placement of advertisements (say banners) in chat windows presented to visitors.

The advertising engine 62 may also match banners to websites, according to relevancy of the banners to the content of the website or to content of a chat between a visitor and an owner, as described in further detail hereinabove. For example, the advertising engine 62 may insert a banner which promotes horse gambling to a sport web site, and a banner which promotes financial services to a financial report webpage on a news website.

The advertising engine 62 further monitors revenues from advertising and credits accounts, according to a pre-defined revenue sharing agreement.

Optionally, the advertising engine 62 retrieves information from advertising networks, as described in further detail hereinabove. The advertisement networks provide APIs that gives content usage information, marketing information, financial information, etc. The advertising engine 62 stores the information provided from the advertisement networks in the persistent database 23, as described in further detail hereinabove.

The account manager 25 may further include a service and credit module 63.

The service and credit module 63 receives from the metered usage counter 61, usage data for each content item, and compares the received data to terms of service usage and account credit data, predefined per each account.

When the received data indicates a deviation from the terms of service usage and account credit data, the service and credit module 63 may warn customers who own of the account, bill the account, etc., in accordance with rules pre-defined by an authorized administrator, as known in the art.

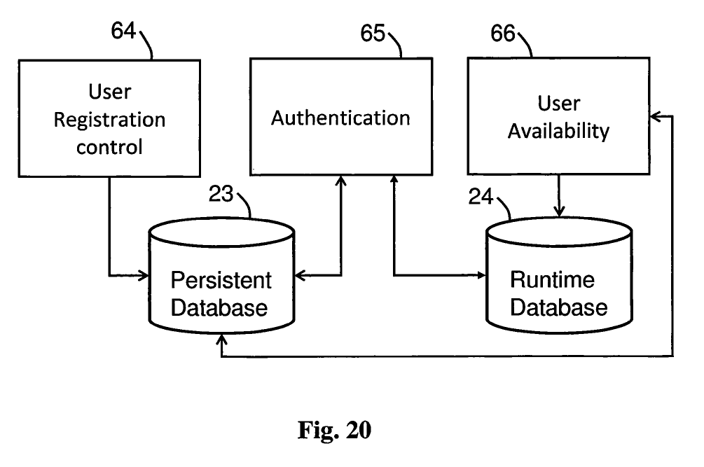

Reference is now made to FIG. 20, which is a block diagram schematically illustrating a user manager for communication in context of content, according to an exemplary embodiment of the present invention.

The user manager 26 is typically responsible for the administration of users (say content owners and system administrators), for authenticating users when they log in, and for monitoring availability of the users, as described in further detail hereinabove.

The user manager 26 includes a user registration control module 64.

The registration control module 64 registers new content owners as users of the system implemented 4 on the computer server, as described in further detail hereinabove.

The registration control module 64 further manages a user password system, as known in the art. The registration control module 64 stores user specific data (such as the user's password and the user's authorizations) on the persistent database 23, as described in further detail hereinabove.

The user manager 26 further includes an authentication module 65.

The authentication module 65 is activated when a user (such as a content owner) logs in to a system 4, either through a website or using a socket based client, as described in further detail hereinabove.

The authentication module 65 validates the user's username and password against the username and password stored on the persistent database 23. Once the user is authenticated, the authentication module 65 lets the user log in, and records the user's logging on the runtime database 24, as described in further detail hereinabove.

The user manager 26 further includes a user availability module 66.

The user availability module 66 determines availability of a user (say a content item owner) from information stored on the runtime database 24.

The user availability module 66 further takes into consideration an availability rule for the user.

Optionally, the availability rule is stored in the persistent database 23 during user registration and account settings, as described in further detail hereinabove.

Exemplary availability rules may based on one or more criterions, such as user authentication, user's being busy in a chat-room, user specific availability time schedules, user's being allowed to chat simultaneously, etc., as described in further detail hereinabove.

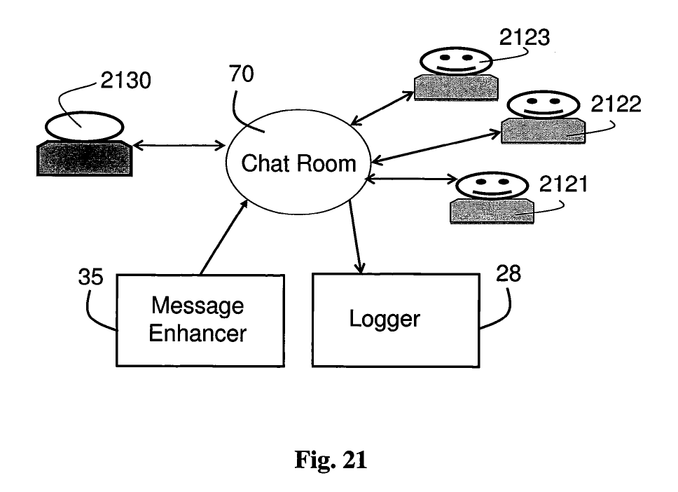

Reference is now made to FIG. 21, which is a block diagram schematically illustrating a chat-room, for communication in context of content, according to an exemplary embodiment of the present invention.

Optionally, the communication data selector 220 and the communication channel establisher 230 are implemented as a single communications manager 22, as described in further detail hereinabove.

The communications manager 22 establishes a communication channel between the visitor 2130 and each of the selected owners 2121-3, through selected communication methods, as described in further detail hereinabove.

By establishing the communication channels between the visitor 2130 and the selected owners 2121-3, the communications manager 22 opens a virtual chat-room 70 for the visitor 2130 and the selected owners 2121-3, to communicate through.

Optionally, the communication channels established by the communications manager 22 connect more than one visitor to more than one owner, say different visitors who interact with different content items of the same owner, etc., as described in further detail hereinbelow.

In a one-to-many example, the chat-room 70 includes communication channels established for a single visitor 2130 and three owners 2121-3 of the same content item.

Optionally, the chat-room 70 is based on more than one communication methods, as described in further detail hereinabove.

In the on-to-many example, an owner 2121 communicates with the visitor 2130 and other owners 2122-3, using a socket based client agent of a VoIP telephony service, such as Skype™, while a second owner 2122 communicates with the user 2130 and other owners 2121, 2123, through an instant messaging service (say ICQ™).

Further in the example, the third owner 2123 uses a Public Switched Telephone Network (PSTN), while the visitor 2130 uses a smart mobile phone (such as an Apple™ iPhone or a RIM™ Blackberry smart phone), as described in further detail hereinabove.

The rules that determine how and when each content owner is connected to the chat room can vary between content owners, content items and accounts.

Optionally, the communications manager 22 allows each of the content owners 2121-3, to connect and disconnect to the chat room by textual commands, graphical controls in an application, inactivity rules (say to disconnect automatically when the owner does not type for more than five minutes), or any other mechanism.

Optionally, the communications manager assigns nicknames to different owners.

Optionally, the communications manager 22 allows one owner to have different nicknames (thus creating an impression of a large corporation), multiple owners to have the same nickname (to be seen as one agent who picks up the chat every time), etc. However, the communications manager 22 may still let owners know who each nickname's real owner.

Optionally, conversations, say textual messages, chat, video messages, etc., that are transmitted through the chat-room's 70 communication channels, are logged and recorded, say by the logger 28, as described in further detail hereinabove.

Optionally, the messages are intercepted, processed and enhanced by the message enhancer 35, as described in further detail hereinabove.

The message enhancer 35 may also submit information about a chat which takes place in the chat room 70, on a special control channel which is neither shown in text chats nor heard or viewed in audio and video chats.

The control channel can be used by message enhancer 35, to present additional information about the call, or send information to a third party application, as described in further detail hereinabove.

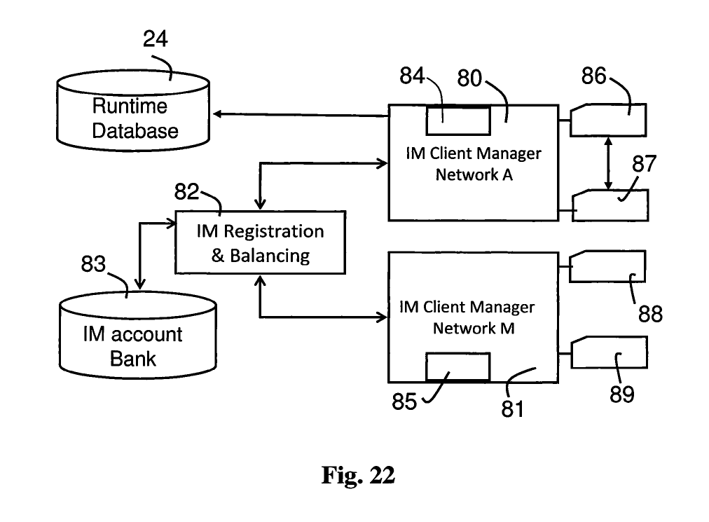

Reference is now made to FIG. 22, which is a block diagram schematically illustrating an instant messaging manager, for communication in context of content, according to an exemplary embodiment of the present invention.

Different instant messaging services may constitute some of the communication methods of the owners, as described in further detail hereinbelow.

An instant messaging manager 27 monitors availability of content item owners through the owners' instant messenger services (such as Skype™), and manages an interface to the different instant messaging services, as described in further detail hereinabove.

The instant messaging manager 27 uses an array of one or more IM (instant messaging) clients 86-89, for each instant messaging service in use by the instant messaging manager 27.

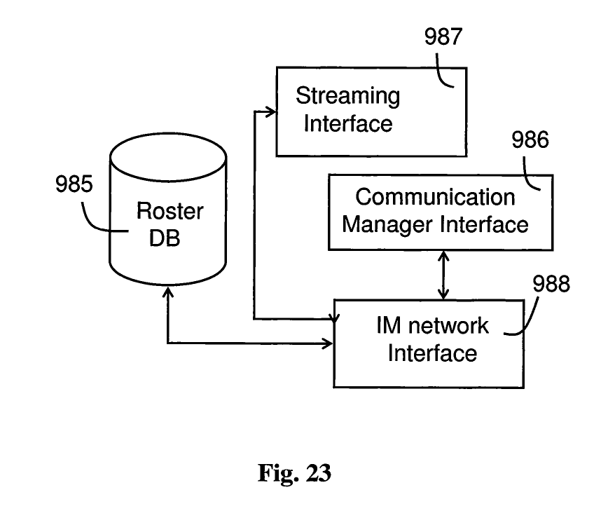

For example, the instant messaging manager 27 may include an array for ICQ™, an array for Google™ Chat, an array for Skype™, etc., as described in further detail and illustrated, using FIG. 23 hereinbelow.

The instant messaging manager includes at least one IM client manager per an Instant Messaging (IM) service.

In one example, a first IM Client Manager 80 manages an array of IM clients 86, 87 that are connected to a first IM service.

Each owner's IM client communicates with one of the IM clients 86, 87 in the array of IM clients for the IM service used by the owner.

The first IM Client Manager 80 gets the availability information of owners on the first IM service, through the IM clients 86, 87, as described in further detail hereinbelow.

The first IM Client Manager 80 stores the availability information in the runtime database 24, as describe in further detail hereinabove.

The first IM Client Manager 80 also manages the basic settings and configuration of the IM clients 86, 87.

Optionally, the IM Client Manager 80 further includes a watchdog module 84.

The watchdog module 84 resets IM clients 86, 87, when the clients 86, 87 do not experience changes in owner's availability during a pre-defined period of time (say five minutes), as described in further detail hereinbelow.

The IM client manager 80 further consolidates IM user availability data from multiple ones of the clients, say for determining availability of an owner who uses more than one instant messaging service.

Optionally, when a visitor interacts with a content item and a certain owner is pre-assigned to the content item, the IM client manager 80 may be the one to select an IM client (of a respective IM service), to use, for establishing a communication channel between the owner and the visitor.

Similarly, in the present example, a second IM Client Manager 81 manages an array of IM clients 88, 89 that are connected to a second IM service, and also has a watchdog module 85, as described in further detail hereinabove.

The instant messaging manager further includes an IM Registration and Balancing Engine 82.

The IM Registration and Balancing Engine 82 adds a content owner to a roster of one of the IM clients 86-89, using the IM Client Manager 80, as described in further detail hereinbelow.

A roster is a list of contacts in the respective IM service user account, as known in commonly used instant messaging services. Exemplary rosters include, but are not limited to: Skype™ Contacts, Facebook Friends, etc.

Using the rosters, each of the owners is assigned to a specific client, according to the IM service the owner uses.

Further, the IM registration and balancing engine 82 attempts to distribute owners between the IM clients 86-89, in a balanced manner.

By distributing the owners in a balanced manner, the IM registration and balancing engine 82 may prevent a condition in which one IM client has many owners, while another IM client has few owners.

The load balancing may help overcome limitations and security checks commonly used on IM services, as known in the art.

Furthermore, once one of the IM Clients gets to a limit (say a predefined maximal number of owners assigned to the client), the IM registration and balancing engine 82 automatically initiates a new batch of IM Clients, and connects the new IM clients to an IM account which is retrieved from an IM account bank 83.

The IM account bank 83 is a database which holds lists of new IM clients (i.e. IM user accounts, say a Google™ Chat account) per each type of IM service (say Google™ Chat), and stores the username and password for each of the IM user accounts.

Once the IM Client Manager 80 allocates the content owner to a specific IM client (say to IM client 87), the IM Client Manager 80 adds the content owner's own IM account to the IM client's 87 account's roster.

Then, the IM Client Manager 80 uses the IM Client 87, to send the content owner's own IM client, an invitation to connect with the IM Client 87.

Once the owner accepts the invitation, his availability status is reported to the IM Client 87. Consequently, the IM Client 87 communicates with the owner, thus enabling establishment of a communication channel between the owner and one or more visitors.

Reference is now made to FIG. 23, which is a block diagram schematically illustrating an instant messaging client, for communication in context of content, according to an exemplary embodiment of the present invention.

Each IM client (such as one of clients 86-89) has a single roster of content owners on a single IM service (say Skype™), as described in further detail hereinabove.

Exemplary rosters include contact list of a Skype™ account, Facebook™ friends, etc.

The IM client uses an interface 988 to the IM service, which the IM client belongs to.

Using the interface 988, the IM client connects to the respective IM service, and receives roster updated and status of the users of the owners included in the roster.

The IM client further sends and receives messages, using the interface 988.

The IM client records the status changes of the roster in a local file or database 985 of rosters.

The IM client further reports the roster status changes, to the IM Client manager 80, which stores the changes in the runtime database 24, as described in further detail hereinabove.

The IM client further uses a communication manager 22 interface 986 to send messages directly to the communication manager 22, as described in further detail hereinabove.

The IM client communicates with the communications manager 22, through the communication manager interface 986, and converts messages received in a specific protocol used by the IM service, to an internal form.

The IM client further uses a streaming interface 987, for creating a streaming session which connects the IM service to a VoIP or a video gateway 32, as described in further detail hereinabove.

Each IM service has its own set of clients, which can communicate through the specific IM network protocol.

The communications manager 22 may forwards the converted messages to a chat-room 70, as described in further detail hereinabove.

The IM client may further deliver audio and video streams to the streaming service 34 through the streaming interface 987.

Each of the owners may install an owner client application on his computer or mobile phone, as described in further detail hereinabove.

Alternatively, the owner may use a web browser as an owner-client.

The web browser based web-client is left open on the owner's computer when the owner is online. The web browser based client opens a small window with an active script that provides most of the information and functionality of installed applications, as known in the art.

The advantage of the installed client application is that the client application automatically loads at computer startup, and therefore the owner does not forget to load the application when he is online.

However, an exemplary embodiment includes both options for the content owners to decide upon. A content owner who installs the application client on his computer is also referred to hereinbelow as a socket owner.

A system according to an exemplary embodiment may connect socket owners, owners reached through other networks and visitors together, in a single chat-room, as described in further detail hereinabove.

The installed application is software that is installed on the content owner's computer. The software may work on several operating systems, such as Microsoft™ Windows, Apple™ Mac OS, etc. The installed application may also be set to operate as a stand-alone application or as a desktop widget, as known in the art.

The installed application may also works on a mobile phone operating system, such as Symbian, Andriod, iPhone, etc. Multiple versions of the installed application may be offered for the owners to download.

The owner client, whether in the form of a browser window, a widget, or a stand-alone application, may connect to multiple content items (say through a button placed next to each of the content items) placed on a single website or on multiple websites.

The owner client application may have, but is not limited to the following functionalities:
Monitor the owner's activity on his computer, and if he is not active for a pre-defined number of minutes, then assume he is offline. An example for such functionality is Skype™ IM program, as known in the art.
Provide an alert to the owner when a visitor views his content (say a combination of audio and visual notifications), according to preferences set by the owner.
Provide an alert to the owner when a certain criterion is met, by telling the owner to expect a call, or by advising the owner to highlight a button placed next to the owner's content item, on a website.
Establish a chat conversation, a voice call or a video phone call.
Establish a phone call, where the system calls both the owner's fixed line phone and the visitor's phone.
Show statistics on the content item. Such statistics may include but are not limited to: a number of visitors who view the owner's contact items, a number of clicks on the content item, duration of visits, how many views over a number of minutes, conversations, left messages, etc.
Configure the owner's settings, such as personal information, contact information, system functionality preferences, alert preferences, etc
Save chat conversations and select items to for FAQ, as described in further detail hereinabove.
Record voice and video conversations.

In some embodiments of the present system, the system may be configured to monitor the owner's and visitors communications and visits. The owner is known, since the owner is registered in the system. The visitor may be marked by placing a cookie on his computer, by remembering his IP address. Optionally, a specific browser used by the visitor, a specific screen resolution in use, etc., may also help identify the visitor.

Since a system according to exemplary embodiments, may be installed in a plurality of websites, it is possible to track usage information, such as: which websites a person visits, where does the visitor clicks, and the content of the visitor's discussions with content owners.

The tracked information may help construct a profile of that person, which can contain information about what the visitor likes or is interested in, as well as behavioral information and tendencies, say in a dating web sites, as described in further detail hereinbelow.

When a visitor enters a webpage, the system or the owner's client, determines if the visitor is a new visitor, or a returning visitor. If a user is a new visitor, the exemplary system automatically registers the visitor. The exemplary system places a cookie on the visitor's computer, or mark the visitor by some other means.

If visitor is already known (i.e. a returning visitor) to the system, the contact trigger mechanism 40 and the advertising engines 42 may use the information as inputs, as described in further detail hereinabove.

An example of how a monitoring and profiling functionality, according to exemplary embodiments of the present invention works is as follows:
a. A visitor visits an e-commerce website, and initiates a chat with a seller who sells a specific bike. The visitor is automatically marked and registered in the system.
b. The same visitor goes to another page in the website that deals with television sets. The exemplary system can then show there an ad about bicycles or helmets.
c. Then, the same visitor visits another website, which also uses the exemplary system. The system recognizes the user, and even if the website deals with something else, the system still presents advertisements of bicycles and televisions to the visitor.
d. Finally, the visitor goes to visit another bike related website. Consequently, the website immediately invites him proactively to chat, since the visitor is marked as someone interested in bicycles. The system may also list for the seller, some of relevant keywords from a previous chat, in order to give the seller a head start in the selling process.

### Usage Examples

The following section provides examples for the way the exemplary system can be integrated into various types of websites. Additional modules that enhance the experience of the system users in the various websites are also described. The additional functionality modules described in each type of website are independent of the specific website, and may be used in any type of website.

Business Websites

The exemplary system may prove useful for very small businesses, in which one or two people are connected to a single service, and also for big corporations, in which there are many different products, each requiring specific expertise. For such cases, it is difficult to have operators in a call center, each one with a knowledge that covers all the details of each product.

One example can be of a large company with multiple products. The company also sells globally, and therefore specific pre-sales and sales people are allocated per region. It is not suitable for such a company to use a call center, as the people there are unable to answer questions asked by professionals. In most cases, specific product pages also don't have sufficient visitors to justify a full-time expert to sit all day and answer.

With the exemplary system, each product is presented using a content item. Each content item has a group of people (i.e. owners) who are responsible for it. The exemplary system can decide to call an owner who is responsible for sales in Asia, if it recognizes that a visitor's IP address belongs to an Asian country. Once the owner accepts the call, the system can display his name, photo, and title or any other personal greeting from him, to encourage the visitor to establish personal contact with an owner, by clicking on a content item (say ad), which offers the product to the visitor.

If no one from the group is available, the system can convert automatically to SMS or Email, or divert to a company call center with people who can take a message. Each interaction may be recorded and archived per content item and web page.

Social Networks

An exemplary system of the present invention may prove beneficial for social networks. The idea of social networking sites is to provide tools that allow people to interact with each other.

Social networking sites, such as Facebook.com also have chat functionality between members who happen to be simultaneously logged into the website. Other sites only have text message communications. With the exemplary system, people may be contacted in real-time without being logged into the same social networking website.

Social networks can implement rules which define when a member of the social network can communicate and with whom. The rules can be set by each of the members of the network. Some exemplary and non-limiting rules are:
a. Only friends (like Facebook friends) allowed to communicate
b. Only first or second degree friends allowed to communicate
c. Only members from a certain geographical region
d. Only members with a specific demographic character: male, female, education, age, field of work
e. Members with defined keywords in their profile: such as, common interests, background information, etc.
f. Members that participate in a certain social network group. Such as: University Alumni, professional group, hobby group, fan group, company, etc.
g. Members of a certain type. For example, a person who needs a new job can allow any head-hunter to view his profile and contact him.
h. Allow communications only at specific times and days. For example, only in the evenings and not during weekends.
i. Restrict communications to up to certain times a day or week.
j. Members with a specific usage parameter can communicate. For example: premium members, members with more than 500 friends, active members, etc.

In a social network implementation, the Application Control Channel 43, illustrated using FIG. 16 hereinabove, may be implemented for applications that can be synchronized between social member friends. An example for such an application is a game.

Further, in the social networks, the message enhancer 35 may be used to deliver enhanced experience to the communications, say in dating web sites, as described in further detail hereinbelow.

By making use of the logger 28, it may be possible to use the exemplary system to allow members of a social network to leave messages to other members. The left messages may be textual, audio, video, etc.

The members may use the exemplary system to retrieve messages through any network supported by the exemplary system. Examples include but are not limited to:
a. Messages retrieved from a website.
b. Messages from a desktop application.
c. Instant messenger network messages.
d. As audio from a voice based network. Text messages can be in this case transformed to audio using text-to-speech technology, say by the message enhancer 35, and video messages can play only the audio if retrieved from an audio only communication method.
e. From another social network that can be connected to the system. For example, the member can retrieve his messages while viewing his television set, as long as the television set has a data connection that can communicate with the exemplary system and retrieve the messages.

Some embodiments of the present system for social networks may allow a several webpage visitors and content owners, to communicate together.

That is to say that when a chat room 70 is opened for a specific content item, it may be used as a many-to-many chat-room. When additional visitors wish to communicate with the content owners, the visitors are allowed to join the existing open chat-room, instead of opening a new chat-room. Consequently, discussion groups may take place in a chat-room, in which several people use the website browser and several people use other networks, and the exemplary system connects all of them for a joint discussion in a single chat-room.

The exemplary system may also be used for polling and voting processes on social networks and on similar sites. At a given time users can be asked one or more questions, and can respond immediately through one of the networks supported by the system. An example to similar usage is in SMS-based voting popular in television shows, where people have a limited time to vote for their favorite contestants.

Classified Ads

In classified ad sites, multiple sellers are competing to sell their products or services on a single website. If a seller appears to be available on line, a visitor is likely to contact him directly, compared to writing emails to other sellers who are not available when the visitor visits the website. In this case, every ad is a content item and the same owner may have several content items on the same specific classified ads website.

The message enhancer 35 may carry out a variety of message processing and enhancement tasks, including but not limited to: Lie detection in voice, Video analysis, Text transcript analysis, Auto answering, Fraud detection, Automatic FAQ and Commercial trend analysis (say one which is based on opinions expressed visitors who chat with content owners), as known in the art.

In some embodiments, it is possible to implement a semi-automatic questions and answers composing functionality to the content. Near the content button, there may be placed a label that opens a FAQ list window. The group administrator and content owners are able to add questions and answers to the FAQ list in several methods:
a. Manual editing of questions and answers from a webpage or from the owner's client.
b. Marking of a section in a chat discussion, in which a visitor asks something, and the owner answers and selects the question and answer for a FAQ database, as described in further detail hereinabove.
c. Automatic Questions and Answers formation from just monitoring chats by the owners and visitors and intelligently converting them into FAQ. An exemplary embodiment for such a function includes: Running a spelling and grammar check and correction function on the messages, Identifying keywords which help understand the context of the question and answer, Identifying repetitive answers, repetitive questions, and adding them to the FAQ, and Prioritizing answers in the FAQ according to the frequency of their occurrences.

In some embodiments, the FAQ list can also appear in the owner's chat window, and the owner is able to paste answers from the FAQ into his current chat window. The owner is also capable of assigning short codes to each FAQ answer, and then uses these codes as short-cuts in his textual correspondence.

The message enhancer 35 may further extract FAQ messages from audio calls and video communications. FAQ responses can be presented both as text, audio and video.

An advertising engine 42 implemented in classified ads website may analyze the information passed in chats, and insert relevant advertisements to chat windows, as described in further detail hereinabove. Another way to target advertising is by knowing in which section the ad is, and present ads relevant to the topic of the section. Cookies may also be used to monitor visitor's activities in a website, and direct relevant ads to that person.

Statistical information gathered per ad, by the logger 28, may provide guidance to the sellers about the attractiveness of their ads to visitors and compare them to known figures in a specific category of ads.

For example, if a user advertises a car for sale, the system can tell him that in the car category, the average number of chats per ad is five per a day. The system may also tell the user that his ad has 50 times in a specific day, compared to other ads in his category which have 200 views in the same day. Therefore, the user needs to improve the wording of his ad or lower his price in order to improve results.

Using the exemplary system, the statistical information may be obtained independently of the classified ads website. Further, the exemplary system may provide a simple way for websites to provide detailed statistics per ad and suggestions for improvement.

Business Directories

Business directories store many different business indexes. For a business directory, a contact trigger mechanism 40 may prove useful and can be activated when a visitor enters the business's profile page according to pre-defined rules and triggers, as described in further detail hereinabove.

Dating Websites

Dating websites are similar to social networks, with a common wish of the members to get to know each-other. Most dating websites today have chat features. However, both members are required to be logged into the site at the same time. This requirement reduces significantly the availability of the members and therefore their success in finding the right partner.

A system according to an exemplary embodiment of the present invention may solve the problem, by allowing a member who visits a profile (i.e. a visitor who interacts with the content item, which is the profile), to chat with the profile owner, even when the owner is not logged in to the dating website.

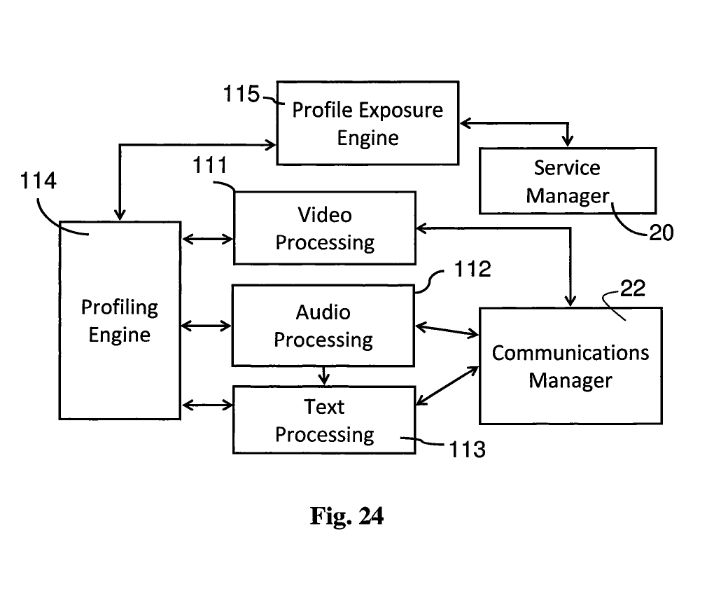

Reference is now made to FIG. 24, which is a block diagram schematically illustrating an eleventh exemplary system, for communication in context of content, according to an exemplary embodiment of the present invention.

An exemplary system, according to an exemplary embodiment of the present invention, may be implemented on a dating web site.

The exemplary system includes the service manager 20 and the communication manager 22, as described in further detail hereinabove.

The exemplary further includes a message enhancer 35, as described in further detail hereinabove.

The message enhancer 35 may include a video processing module 111, an audio processing module 112, and a text processing module 113.

The message enhancer 35 analyzes messages transmitted between members and builds an optimal profile of people a member likes most.

Today, websites like Amazon.com study a user's activities on their site, and recommend additional things that are suitable for the specific user.

Websites like Pandora.com play various songs to a person, and asks for their opinion on the songs they hear. According to the opinions, Pandora constructs a profile of that person's personal music listening preferences, and then plays songs which fit these criteria.

A concept behind the implementation of the exemplary system in dating websites may be to use the communications between the members, and their feedback afterwards, in order to construct a profile of the member's personal taste in other people. The exemplary system detects correlation between the communications data and the feedback provided by the person after the communication event. The system learns each member's reactions, and profiles the types of people, the member is likely to prefer.

The text processing module 113 detects clues in text. The text processing module 113 may extract the text from textual chat messages, or from audio messages, which the text processing module 113 converts to text, using speech to text conversion technology, as known in the art.

The text processing module 113 searches the text and flow of conversation, in the text, and profiles the person who chats (say the dating website member).

The text processing module 113 may profile the person using different criteria, including, but not limited to:
a. Length of messages of each member.
b. Keywords that indicate hobbies, favorite films, books, things liked.
c. Keywords that indicate interest groups, affiliations, schools or anything else that can add to a person's profile. In many cases, people provide very limited information in the profile, but during conversations more information is revealed that can help profile the person.
d. Likes and Dislikes.
e. Positive and negative words.

The audio processing module 112 may simply intercept audio messages and forward the messages for speech-to-text conversion, by the text processing module 113. Alternatively, the audio processing module 112 converts the audio messages to text, and forwards the text to the text processing module 113, for further processing, as described in further detail hereinabove.

Optionally, the audio processing module 112 further detects vocal characteristics during an intercepted conversation. The vocal characteristics may be useful for profiling the members and the interaction between them. Exemplary criteria that can help profile people according to the vocal characteristics include but are not limited to:
a. Tone of voice—Shaky voice, stable voice, Pitch, etc.
b. How the people speak: fastly, slowly, loudly, softly, with short sentences, with long sentences, etc.
c. People reactions: laughter, giggling, enthusiasm, boredom.

The video processing module 111 analyzes video conference streams and profiles participators in the video conference. Exemplary criteria that the video processing module 111 may use, for profiling the participators, include but are not limited to:
a. Facial features—Looks, color of eyes, hair, skin, freckles, distance between eyes, nose, mouth, dimensions of nose, mouth, lips, eyes, etc, as known in the art.
b. Body features—Thin, obese, freckles, chest size.
c. Gestures—Smiles, facial expressions, body movements, restlessness.

The exemplary system further includes a profiling engine 114.

The profiling engine 114 receives the data from the processing modules 111,112,113.

The profiling engine 114 records all the received data in a dedicated member database. The profiling engine 114 profiles a member using many possible parameters the profiling engine 114 calculates for a specific conversation or chat. The profiling engine 114 further compares the calculated parameters to parameters calculated for previous communications by the member, in order to derive a more accurate profile for the user.

The profiling engine 114 may further use feedback from members of the dating web site. For example, the website may allow a member to rate other members, using a form, etc. In order to receive the feedback from the website, the profiling engine 114 communicates with the website, through an API controlled by the API module 21, as described in further detail hereinabove.

The profiling engine 114 may also calculate parameters based on interaction development (say of a conversation). For example, the profiling engine 114 may learn that a certain girl responds positively, with laughter and positive facial expressions, to guys that speak fast, in short sentences, and with enthusiasm.

Optionally, the parameter set obtained by the profiling engine 114 and message enhancer modules 111-113, presents a useful expansion of user profiles, which the owners of the dating websites can use to intelligently differentiate themselves from others by better profiling of people and matching them.

The exemplary system may further include a profile exposure engine 115, which matches between members using data generated by profiling engine 114, as described in further detail hereinbelow.

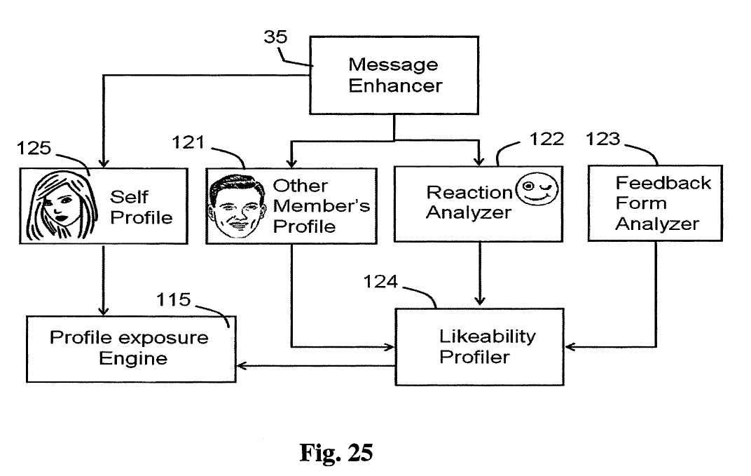

Reference is now made to FIG. 25, which is a block diagram schematically illustrating a profiling engine, for communication in context of content, according to an exemplary embodiment of the present invention.

A system according to an exemplary embodiment of the present invention, may include a profiling engine, as well as other parts, as described in further detail hereinabove.

The profiling engine is in communication with the message enhancer's 35 modules 111-113, as described in further detail and illustrated using FIG. 24 hereinabove.

The message enhancer's 35 modules 111-113 generate data about the text, audio and video chats by members of the dating website.

The profiling engine includes a reaction analyzer 122.

The more chats (or other interactions) a member has with other members, the more accurate the member's profile becomes. Since members can look and behave differently at different times, the profiler engine may derive several profiles for the member.

The reaction analyzer 122 analyzes reactions of the member to other members, say using facial analysis by the video processing module 111, as described in further detail hereinabove.

The profiling engine further includes a feedback form analyzer 123, which receives information forms filled out by the member, in the dating website, through the APIs, as described in further detail hereinabove. The feedback form analyzer 123 analyzes information in the received filled out forms.

The profiling engine may further receive the member's dating profile 121 (i.e. his profile as presented on the website), from the web site, say by the message enhancer 35.

The profiling engine further includes a likeability profiler 124.

The likeability profiler 124 calculates a likeability profile for the member.

The likeability profiler 124 calculates the likeability profile (say a set of ratings) using data analysis information generated by the feedback form analyzer 123, the reaction analyzer 122 and the member's profile 121.

Optionally, the likeability profiler 124 further uses parameters previously calculated by the profiling engine.

The likeability profiler 124 saves the member's profile 112 and the likeability profile in a dedicated rated profiles database.

When a member is active in the dating web site, the profile exposure engine 115 retrieves dating profiles of other members 121 together with a respective likeability profile for each other member, from the rated profiles database.

The profile exposure engine 115 further retrieves the profile 125 of the member active in the dating website, and uses the retrieved profiles 125, 121, to match between the active member and other members.

The profile exposure engine 115 may further give recommendations to the member, say on other members the member should try to interact with.

Optionally, the profile exposure engine 115 further uses the recommendations together with input received from the dating website, to generate an availability rule for the member active in the dating website.

The generated availability rule indicates which of the members is allowed to contact the active member, and which members the active member is allowed to contact.

The profile exposure engine 115 sends the availability rule to the service manager 20, as described in further detail hereinabove.

The profile exposure engine 115 may further carry out a speed-dating process in which members are matched, as described in further detail hereinabove.

Next in the speed dating process, matched members are connected for a limited time and then, are prompted to rate each other. Towards the end of the speed dating process, matches are likely to be better, as ratings from members active in the speed-dating process are continuously gathered and taken into consideration by the profile exposure engine 115, in the matching process.

Another feature that is enabled by the exemplary system is the ability to allow two members in a shared chat room (be it text based or video based) to decide to have a private discussion. This feature exists today in chat rooms, but with the present embodiments, it may be extended to instant messengers, video and voice.

Tourism Related Sites

One of the problems in tourism related sites is that in most cases website visitors are located in a distant physical location compared to the content owners. This requires expensive international calls, and may hit language barriers and time-zone differences.

The present embodiments may offer free or low cost communications between website visitors and show actual availability of the sellers—so that the time-zone guessing problem is hopefully eliminated.

In a tourism related website, additional features can be added in order to provide a more suitable solution.

One feature is to pass the messages through a machine translation device which connects to the message enhancer. It is possible in the visitor's client to identify the location of the visitor, and the location of the content owner, and to offer them translation and automatic spelling correction.

Another feature is to synchronize a map or similar application on the visitor's device and on the content owner's device, say using the exemplary system 3000, as described in further detail hereinabove.

Content Sharing Sites (Blogs, Photo Sharing, Video Sharing)

There are many websites in which users contribute their work, be it photos, videos, text or audio, and website visitors leave them comments. The exemplary embodiments enable content owners to receive instant feedback, and to engage in conversations with people who are interested in their work. This can be much more gratifying than just reading short comments.

Similar to the social networks, the exemplary embodiments may provide a chat room in which several visitors to a specific content can communicate at the same time between themselves and with the content owner or owners.

The exemplary embodiments may also provide statistics to the content owners, and overcome language and long distance barriers similar to the tourism solution.

Talkbacks

In news and culture sites, as well as in blogs visitors are can leave comments (talkbacks).

A content author (i.e. owner) can place button, and allow a visitor to contact him using chat (i.e. a content item), upon clicking on the button. Similarly, it is possible to allow every talkback contributor to put a chat button on his talkback post and allow other visitors to directly talk with them, upon clicking on the button.

In addition to the direct and immediate way of communications between a visitor with similar interests, the chat may allow private discussion to spawn from the posted comments and at the same time may reduce the amount of irrelevant slur and spam that talkbacks frequently suffer from.

Auction/e-Commerce Sites

Auction and e-Commerce websites can implement the exemplary systems of the present invention, thus allowing buyers to connect to sellers easily. These websites can implement rules that restrict buyer connectivity according to a set of criteria such as preferred languages, physical location, etc.

The message enhancer 35 may implement mechanisms that can detect if a person lies, and try to warn from fraud, as described in further detail hereinabove.

The FAQ mechanism described earlier is also suitable for such websites, as described in further detail hereinabove.

Auction sites can also ask website visitors to register to the site. During their registration process they can enter their instant messenger details, mobile phone number or any other connectivity method. The auction site can then use the exemplary system to communicate with a large number of users instantly through their IM's, SMS or any other type of communication method. This can be used to provide alerts to visitor's who placed a bid in an auction, or to inform people on a limited time offer (like a happy hour).

Job Posting Websites (Such as Elance or Monster)

The exemplary system may be implemented in job sites, to connect people who want to hire other people. This can be for free-lancers and for full time employment. In such sites, it is possible for the people who want to be hired to allow people to contact them from their profile.

In many cases, an employer needs to interview the person. With the exemplary embodiments, such an interview can be done directly from the site, using text, audio and video. Additional features such as meeting coordination and reminder can also be implemented. The features may rely on the exemplary system to send reminders and alerts to both sides, in order to make sure they are available for the interview. The exemplary embodiments also allow several people from the employer's side to participate in the interview, and the interview may also be recorded.

The message enhancer can add information about the conversation, say for detection of lying or any other stressful situation.

Intranet (Company, University, Other Organization)

The exemplary system, when implemented within an organization, can bring a new level of simplicity in the internal communications. In this case, the website may be an organization's website used mainly by employees of that organization, but can be also be opened to partners, customers or the general public.

In the organization's website, there can be a directory of people, and profiles of people. When a visitor to that website searches for a specific person, the visitor may see immediately if the person is available right now on his instant messenger, and can contact him immediately. If the person is not online, it is still possible to communicate with him through any other network which is connected to the exemplary system. This enables the communications from the website to be seamless and direct to the person.

The same implementation can add a feature of announcements to groups of users. This can be announcements of organizational nature, or announcements for a specific group of people. The exemplary system can automatically choose the network through which each person is contacted. Additional logic can be added to allow each person who receives a message to respond to it, and confirm that he received it. An example for such use is to use the system to alert users when a scheduled meeting is postponed, and the system may immediately alert all participants, and send their response to the meeting scheduler.

The system can also be used to send reminders to people prior to important meetings, events or deadlines.

Help/Support/Q&A/Training Related websites

There are companies who can provide chat support by an array of low cost operators. Such companies are web hosting companies, Internet Service Providers or companies with a relatively simple product which is sold to a large number of customers.

Many other companies, are required to support products which need a higher level of expertise, and have much less customers per product. Therefore, the standard support method, of using a call center with operators does not bring economic value.

With a system according to an exemplary embodiment of the present invention, it may be possible to add to such a company website a service per product, and connect each service to a group of experts that can answer questions on that specific product.

The identification of the experts can be implemented in several ways such as:
A question button placed near the content item, on which a visitor may click, for connecting to experts relevant to a product represented by the content item.
A combo box or similar method in which the visitor can indicate the topic of his interest
Message processing, for identifying keywords in the visitor's question.
Matching the visitor's preferred language to an expert that speaks that language.

Such websites can also implement the FAQ mechanism, as described in further detail hereinabove.

The visitor's messages may also be converted from text chat to voice and video, as described in further detail hereinabove.

The following are commonly used definitions for terms used hereinabove. The definition given below should not be construed as limiting, as alternative definitions, modifications and variations, given hereinabove, and/or any other definition apparent to those skilled in the art may replace the definitions provided hereinbelow.

### GENERAL DEFINITIONS

Ad Site

A website that displays advertisements from individual people or companies.

Administrator

A person who manages a system.

Analytics, Viewing Statistics

Web analytics is the measurement, collection, analysis and reporting of internet data for purposes of understanding and optimizing web usage.

API—Application Programming Interface

An Application Programming Interface (API) is an interface implemented by a software program which enables it to interact with other software. It is similar to the way the user interface facilitates interaction between humans and computers. An API is implemented by applications, libraries, and operating systems to determine their vocabularies and calling conventions, and is used to access their services. It may include specifications for routines, data structures, object classes, and protocols used to communicate between the consumer and the implementer of the API.

Application Server

An application server may include a group of one or more computers, in communication with one or more other computers. An application server provides services across a network, either to private users inside an organization (say via an organizational intranet network) or to public users (say via the Internet).

Blog, Blogger

A blog (a portmanteau of the term web log) is a type of website or part of a website. Blogs are usually maintained by an individual with regular entries of commentary, descriptions of events, or other material such as graphics or video. Entries are commonly displayed in reverse-chronological order. A blog can also be used as a verb, meaning to maintain or add content to a blog.

Many blogs provide commentary or news on a particular subject; others function as more personal online diaries. A typical blog combines text, images, and links to other blogs, Web pages, and other media related to its topic. The ability of readers to leave comments in an interactive format is an important part of many blogs. Most blogs are primarily textual, although some focus on art (Art blog), photographs (photoblog), videos (Video blogging), music (MP3 blog), and audio (podcasting). Microblogging is another type of blogging, featuring very short posts.

Business Directories (Online Business Directory)

A Business directory is a website listing of information which lists all businesses within some category. Businesses can be categorized by business, location, activity, or size. Business information may be compiled either manually or through an automated online search software.

The details provided in a business directory may vary. They may include the business name, addresses, telephone numbers, location, type of service or products the business provides, number of employees, the service region and any professional associations. Some directories include a section for user reviews, comments, and feedback.

Chat

Online chat can refer to any kind of real-time communication between two or more people. It can be textual chat, audio, video chat or a combination of text, audio and video simultaneously.

Chat Transcript

A written record of a recorded chat conversation.

Chat Window

The area in a window in which the chat messages appear, chat is controlled, and video chat is presented.

### Classified Ads

Classified advertising is a form of advertising which is particularly common in newspapers, online and other periodicals, e.g. free ads papers or Penny savers. Classified advertising differs from standard advertising or business models in that it allows private individuals (not simply companies or corporate entities) to solicit sales for products and services.

Classified advertising is called such because it is generally grouped within the publication under headings classifying the product or service being offered (headings such as Accounting, Automobiles, Clothing, Farm Produce, For Sale, For Rent, etc.) and is grouped entirely in a distinct section of the website, which makes it distinct from display advertising, which often contains graphics or other art work and which is more typically distributed throughout a publication adjacent to editorial content.

### Company Website

A website (also spelled Web site) is a collection of related web pages, images, videos or other digital assets that are addressed relative to a common Uniform Resource Locator (URL), often consisting of only the domain name, or the IP address, and the root path (′/′) in an Internet Protocol-based network. A web site is hosted on at least one web server, accessible via a network such as the Internet or a private local area network.

A webpage is a document, typically written in plain text interspersed with formatting instructions of Hypertext Markup Language (HTML, XHTML). A webpage may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the webpage content. The user's application, often a web browser, renders the page content according to its HTML markup instructions onto a display terminal.

Content Owner

Optionally, the content owner is a company or individual who placed their content on a website, and/or anyone appointed by that company or individual to use the system and interact with visitors. If it is product related website, then the content owners may be the people who want to sell or promote a product, and place the information about the product. If the website is a social network website, then the person behind a personal profile may be a content owner. If it is a blog, video or image site, then the content owner may be the person who uploaded the pictures, or anyone on his behalf. Content owners may also be employees of a specific company, family members, or any group of one or more persons who are appointed to interact with visitors who interact (by clicking, viewing, etc.) with a specific content item.

The specification occasionally refers to content owners as owners.

Cookie

A cookie, also known as a web cookie, browser cookie, and HTTP cookie, is a text string stored by a user's web browser. A cookie consists of one or more name-value pairs containing bits of information, which may be encrypted for information privacy and data security purposes.

The cookie is sent as an HTTP header by a web server to a web browser and then sent back unchanged by the browser each time it accesses that server. A cookie can be used for authentication, session tracking (state maintenance), storing site preferences, shopping cart contents, the identifier for a server-based session, or anything else that can be accomplished through storing textual data.

Dating Site

Online dating or Internet dating is a dating system which allows individuals, couples and groups to make contact and communicate with each other over the Internet, usually with the objective of developing a personal romantic or sexual relationship. Online dating services usually provide un-moderated matchmaking over the Internet, through the use of personal computers or cell phones.

Online dating services generally require a prospective member to provide personal information, before they can search the service provider's database for other individuals using criteria they set, such as age range, gender and location. Most sites allow members to upload photos of themselves and browse the photos of others. Sites may offer additional services, such as webcasts, online chat, telephone chat, and message boards. Some sites provide free registration, but may offer services which require a monthly fee. Other sites depend on advertising for their revenue.

Many sites are broad-based, with members coming from a variety of backgrounds looking for different types of relationships. Other sites are more specific, based on the type of members, interests, location, or relationship desired.

FAQ

Frequently asked questions, or FAQs are listed questions and answers, all supposed to be frequently asked in some context, and pertaining to a particular topic.

Fixed Phone (Land Line)

Landline (or land phone or main line or fixed-line) refers to a telephone line which travels through a solid medium, either metal wire or optical fibre, as distinguished from a mobile cellular line, where transmission is via radio waves.

Flash

Flash is a multimedia platform used to add animation, video, and interactivity to Web pages. Flash is frequently used for advertisements and games. More recently, it has been positioned as a tool for Rich Internet Applications (RIAs).

Flash manipulates vector and raster graphics to provide animation of text, drawings, and still images. It supports bidirectional streaming of audio and video, and it can capture user input via mouse, keyboard, microphone, and camera. Flash contains an Object-oriented language called ActionScript.

Flash content may be displayed on various computer systems and devices, using Adobe Flash Player, which is available free for common Web browsers, some mobile phones and a few other electronic devices (using Flash Lite). Some browsers, such as Google's Chrome, include the Flash player as an integral part of their browser's engine.

In the description provided hereinabove, the term Adobe™ Flash is interchangeable with Microsoft™ Silverlight, HTML5, or any other present or future technology used for adding multi-media and RIA (Rich Internet Applications) in web browsers or similar platforms.

High-Traffic Sites

High-traffic sites are websites which have significant web traffic.

Web traffic is the amount of data sent and received by visitors to a web site. It is a large portion of Internet traffic. This is determined by the number of visitors and the number of pages they visit.

HTML

HTML, which stands for HyperText Markup Language, is the predominant markup language for web pages. It provides a means to create structured documents by denoting structural semantics for text such as headings, paragraphs, lists, links, quotes and other items. It allows images and objects to be embedded and can be used to create interactive forms. It is written in the form of HTML elements consisting of tags surrounded by angle brackets within the webpage content. It can embed scripts in languages such as JavaScript which affect the behavior of HTML webpages. HTML can also be used to include Cascading Style Sheets (CSS) to define the appearance and layout of text and other material.

HTML5

HTML5 is currently under development as the next major revision of the HTML standard. Like its immediate predecessors, HTML 4.01 and XHTML 1.1, HTML5 is a standard for structuring and presenting content on the World Wide Web. The new standard incorporates features like video playback and drag-and-drop, previously dependent on third-party browser plug-ins such as Adobe Flash, Microsoft Silverlight, and Google Gears.

HTML5 introduces a number of new elements and attributes that reflect typical usage on modern websites. Some elements provide new functionality through a standardized interface.

IM, Instant Messaging

Instant messaging (IM) is a form of real-time direct communication between two or more people using personal computers or other devices, along with shared software clients. The user's text, audio or video is conveyed over a data network, such as the Internet.

Online chat and instant messaging differs from other technologies such as e-mail due to the perceived synchronicity of the communications by the users—chat happens in real-time. Some systems permit messages to be sent to people not currently logged on (offline messages), thus removing some of the differences between IM and e-mail (often done by sending the message to the associated e-mail account).

IM allows effective and efficient communication, allowing immediate receipt of acknowledgment or reply. In many cases instant messaging includes additional features which can make it even more popular. For example, users can see each other by using webcams, or talk directly for free over the Internet using a microphone and headphones or loudspeakers. Many client programs allow file transfers as well, although they are typically limited in the permissible file-size.

Instant Messenger, Messenger

The term Instant Messenger refers to an instant messaging client which is a software application that enables the user to engage in instant messaging. Instant messaging clients utilize one or more instant messaging protocols. Popular protocols include OSCAR (AIM, ICQ), XMPP, IRC, MSNP (Windows Live Messenger), and Skype. Many popular instant messaging clients also include Voice over Internet Protocol (VoIP) and videoconferencing capabilities.

Internet

The Internet is a global system of interconnected computer networks that use the standard Internet Protocol Suite (TCP/IP) to serve billions of users worldwide. It is a network of networks that consists of millions of private, public, academic, business, and government networks of local to global scope that are linked by a broad array of electronic and optical networking technologies. The Internet carries a vast array of information resources and services, most notably the inter-linked hypertext documents of the World Wide Web (WWW) and the infrastructure to support electronic mail.

Intranet

An intranet is a private computer network that typically uses Internet Protocol technologies to securely share any part of an organization's information or network operating system within that organization. The term is used in contrast to internet, a network between organizations, and instead refers to a network within an organization. Sometimes the term refers only to the organization's internal website, but may be a more extensive part of the organization's information technology infrastructure. It may host multiple private websites and constitute an important component and focal point of internal communication and collaboration.

IP Address

An Internet Protocol (IP) address is a numerical label that is assigned to devices participating in a computer network that uses the Internet Protocol for communication between its nodes. An IP address serves two principal functions: host or network interface identification and location addressing.

The Internet Protocol is used to route data packets between networks; IP addresses specify the locations of the source and destination nodes in the topology of the routing system. For this purpose, some of the bits in an IP address are used to designate a subnetwork. The number of these bits is indicated in CIDR notation, appended to the IP address; e.g., 208.77.188.166/24.

Javascript

JavaScript is an implementation of the ECMA Script language standard and is typically used to enable programmatic access to computational objects within a host environment. It can be characterized as a prototype-based object-oriented scripting language that is dynamic, weakly typed and has first-class functions.

JavaScript is primarily used in the form of client-side JavaScript, implemented as part of a web browser in order to provide enhanced user interfaces and dynamic websites. However, its use in other applications is not insignificant.

JavaScript and the Java programming language both use syntaxes influenced by that of C syntax, and JavaScript copies many Java names and naming conventions; but the two languages are otherwise unrelated and have very different semantics. The key design principles within JavaScript are taken from the Self and Scheme programming languages.

Mobile Device

A mobile device (also known as a cell phone device, handheld device, hand held computer or smart phone) is a pocket-sized computing device, typically having a display screen with touch input or a miniature keyboard. An Internet enabled mobile device is such a device which has a connection to a computer network, typically the Internet or a specific network.

Mobile Network/Cellular Network

A mobile/cellular network is a radio network made up of a number of cells, each served by at least one fixed-location transceiver known as a cell site or base station. When joined together these cells provide radio coverage over a wide geographic area. This enables a large number of portable transceivers (mobile phones, pagers, computers, etc) to communicate with each other and with fixed transceivers and telephones anywhere in the network, via base stations, even if some of the transceivers are moving through more than one cell during transmission. Today's mobile networks support text, audio, video and data communications.

Mobile Phone

A mobile phone (also known as a cell phone device, handheld device, hand held computer or smart phone) is an electronic device used for full duplex two-way radio telecommunications over a cellular network of base stations known as cell sites. Mobile phones differ from cordless telephones, which only offer telephone service within limited range through a single base station attached to a fixed land line, for example within a home or an office. Low-end mobile phones are often referred to as feature phones, whereas high-end mobile phones that offer more advanced computing ability are referred to as Smart phones. Smart phones can also connect to networks by typically using a wireless networking method such as Wi-Fi, 3G, 4G, etc.

Online/Offline

Offline: A state in which an individual is not connected to a data network, neither fixed or mobile.

Online: A state in which an individual is connected to a data network, either fixed or mobile.

The terms “online” and “offline” (also stylized as “on-line” and “off-line”) have specific meanings in regard to computer technology and telecommunications. In general, “online” indicates a state of connectivity, while “offline” indicates a disconnected state.

Operating Systems

An operating system (OS) is the software on a computer that manages the way different programs use its hardware, and regulates the ways that a user controls the computer. Operating systems are found on almost any device that contains a computer with multiple programs from cellular phones and video game consoles to supercomputers and web servers. Some popular modern operating systems for personal computers include Microsoft Windows, Mac OS X, and Linux.

Operator, Service Agents

Someone who operators a software that can provide live interaction with visitors.

Owner-Client

A piece of software that runs on the content owner's computer or mobile device. This software can be installed on the owner's devices or run from the owner's web browser.

Cut, Copy, Paste

In human-computer interaction, cut and paste and copy and paste offer user-interface paradigms for transferring text, data, files or objects from a source to a destination. Most ubiquitously, users require the ability to cut and paste sections of plain text. This paradigm has close associations with graphical user interfaces that use pointing devices such as a computer mouse (by drag and drop, for example).

Personal Web Pages

Personal web pages are World Wide Web pages created by an individual to contain content of a personal nature rather than on behalf of an employer or institution. Personal web pages are often used solely for informative or entertainment purposes.

The content of personal web pages varies. Many contain biographical information, résumés, and blog posts. Many personal pages will include information about the author's hobbies, and information of interest only to friends and family of the author.

PSTN

The public switched telephone network (PSTN) also referred to as the Plain Old Telephone Service (POTS) is the network of the world's public circuit-switched telephone networks. Originally a network of fixed-line analog telephone systems, the PSTN is now almost entirely digital in its core and includes mobile as well as fixed telephones.

Proprietary Software

Proprietary software is a piece of software developed by a company for a specific application. Proprietary software is usually created by businesses who want to sell their software, but some of these programs that are free to use.

Real-Time

A term that indicates something that is instant, or a result that happens quickly. For example, most types of communications is considered “real-time”.

Roster

Roster is the name of the contact list of an instant messaging client. Contacts are also referred to as “buddies” or “friends”.

Socket

In computer networking, an Internet socket or network socket is an endpoint of a bidirectional inter-process communication flow across an Internet Protocol-based computer network, such as the Internet.

The term Internet sockets is also used as a name for an application programming interface (API) for the TCP/IP protocol stack, usually provided by the operating system. Internet sockets constitute a mechanism for delivering incoming data packets to the appropriate application process or thread, based on a combination of local and remote IP addresses and port numbers. Each socket is mapped by the operating system to a communicating application process or thread.

Socket Application, Socket User

When a content owner uses an application which connects to the system through a Socket, then that person is referred to as a “user” or “socket user”. The software which is used by him to connect is called a “socket application”. The “socket application” can be software which is installed on a computer or mobile device. The “socket application” can be also a webpage with the same functionality, in which the content owner logs into, and then can communicate with visitors from that webpage. In this case, the webpage serves as his “socket application”.

SMS

Short Message Service (SMS) is the text communication service component of mobile communication systems, using standardized communications protocols that allow the exchange of short text messages between mobile phone devices.

Social Networking Site

A social network service focuses on building and reflecting of social networks or social relations among people, e.g., who share interests and/or activities. A social network service essentially consists of a representation of each user (often a profile), his/her social links, and a variety of additional services. Most social network services are web based and provide means for users to interact over the internet, such as e-mail and instant messaging. There are also social networks that work on an Intranet of a large organization. Although online community services are sometimes considered as a social network service in a broader sense, social network service usually means an individual-centered service whereas online community services are group-centered. Social networking sites allow users to share ideas, activities, events, and interests within their individual networks.

The main types of social networking services are those which contain category places (such as former school-year or classmates), means to connect with friends (usually with self-description pages) and a recommendation system linked to trust. Popular methods now combine many of these, with Facebook, Bebo and Twitter widely used worldwide; MySpace and LinkedIn being the most widely used in North America; Nexopia (mostly in Canada); Bebo, Hi5, Hyves (mostly in The Netherlands), StudiVZ (mostly in Germany), iWiW (mostly in Hungary), Tuenti (mostly in Spain), Decayenne, Tagged, XING, Badoo and Skyrock in parts of Europe; Orkut and Hi5 in South America and Central America; and Friendster, Mixi, Multiply, Orkut, Wretch, renren and Cyworld in Asia and the Pacific Islands and Orkut and Facebook in India.

SSL/TLS

Transport Layer Security (TLS) and its predecessor, Secure Socket Layer (SSL), are cryptographic protocols that provide security for communications over networks such as the Internet. TLS and SSL encrypt the segments of network connections at the Application Layer to ensure secure end-to-end transit at the Transport Layer.

Several versions of the protocols are in widespread use in applications like web browsing, electronic mail, Internet faxing, instant messaging and voice-over-IP (VoIP).

Support Center

A support center, contact center or call center is a centralized office used for the purpose of receiving and transmitting a large volume of requests by telephone, live chat, emails, faxes, letters, etc. A call center is operated by a company to administer incoming product support or information inquiries from consumers. A call center is often operated through an extensive open workspace for call center agents, with work stations that include a computer for each agent, a telephone set/headset connected to a telecom switch, and one or more supervisor stations.

Visitor

A person who visits a web page.

VoIP—Voice Over IP

Voice over IP (VoIP) is a general term for a family of transmission technologies for delivery of voice communications over IP networks such as the Internet or other packet-switched networks.

Web Browser

A web browser is a software application for retrieving, presenting, and traversing information resources on the World Wide Web. An information resource is identified by a Uniform Resource Identifier (URI) and may be a web page, image, video, or other piece of content. Hyperlinks present in resources enable users to easily navigate their browsers to related resources.

Although browsers are primarily intended to access the World Wide Web, they can also be used to access information provided by Web servers in private networks or files in file systems. Some browsers can be also used to save information resources to file systems. Since browsers support also dynamic scripts, such as Javascript, Ajax and Flash, they are frequently used for running web-based software applications, which typically serve as clients that communicate with a remote software module.

Webcam, Web-Camera

A webcam is a video capture device connected to a computer or computer network, often using a USB port or, if connected to a network, Ethernet or Wi-Fi.

Website

A website (also spelled Web site) is a collection of related web pages, images, videos or other digital assets that are addressed relative to a common Uniform Resource Locator (URL), often consisting of only the domain name, or the IP address, and the root path (′/′) in an Internet Protocol-based network. A web site is hosted on at least one web server, accessible via a network such as the Internet or a private local area network.

A webpage is a document, typically written in plain text interspersed with formatting instructions of Hypertext Markup Language (HTML, XHTML). A webpage may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the webpage content. The user's application, often a web browser, renders the page content according to its HTML markup instructions onto a display terminal.

All publicly accessible websites collectively constitute the World Wide Web.

Widget

In computer software, a widget engine is a software service available to users for running and displaying applets on a graphical user interface, such as that of the desktop (this desktop can be run on a non-portable computer or any mobile device).

The widget model in widget engines is attractive because of ease of development. Most of these widgets can be created with a few images and about ten to several hundred lines of XML/JavaScript/VBScript source code. A single host software system, such as a web browser, or operating system runs all the loaded widgets. This allows several desktop widgets to be built sharing resources and code.

Widget engines such as desktop widgets and web widgets are intended for end users. Desktop and web widgets are stand-alone, task-oriented applications which can be composed of several related interactions on its own. Each widget serves only a purpose that is usually addressed by the effort of one GUI widget in a full-scale application.

URL

In computing, a Uniform Resource Locator (URL) is a Uniform Resource Identifier (URI) that specifies where an identified resource is available and the mechanism for retrieving it. In popular usage and in many technical documents and verbal discussions it is often incorrectly used as a synonym for URI. The best-known example of a URL is the “address” of a webpage on the World Wide Web, e.g. http://www.example.com.

XMPP

Extensible Messaging and Presence Protocol (XMPP) (formerly named Jabber) is an open, XML-based protocol originally aimed at near-real-time, extensible instant messaging (IM) and presence information (e.g., buddy lists), but now expanded into the broader realm of message-oriented middleware. It was developed by the Jabber open-source community in 1999. Built to be extensible, the protocol has been extended with features such as Voice over Internet Protocol and file transfer signaling.

Unlike most instant messaging protocols, XMPP is an open standard. Like e-mail, it is an open system where anyone who has a domain name and a suitable Internet connection can run their own XMPP server and talk to users on other servers. The standard server implementations and many clients are also free and open source software.

It is expected that during the life of this patent many relevant devices and systems will be developed and the scope of the terms herein, particularly of the terms “Internet”, “Intranet”, “Computer”, and “Instant messaging” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for communication in context of content, the system comprising:
an interaction data receiver, implemented on a server computer and configured to receive data indicating occurrence of an interaction of a visitor with a content item presented on a computer remote from the server computer; and
a communication method selector, in communication with said interaction data receiver, configured to select at least one owner among a group of owners pre-assigned to the content item and a communication method among a group of communication methods pre-defined for the selected owner, for dynamically connecting the visitor and the selected owner, using the received data and according to a pre-defined selection criterion.

2. The system of claim 1, wherein the group of owners pre-assigned to the content item comprises a plurality of owners.

3. The system of claim 1, further comprising a communication channel establisher, configured to dynamically establish a communication channel connecting the visitor and the selected owner, using the selected communication method.

4. The system of claim 3, wherein said communication channel establisher is further configured to connect the established communication channel with at least one other communication channel, thereby opening a chat-room comprising the connected communication channels.

5. The system of claim 1, further comprising a communication channel establisher, configured to dynamically establish a communication channel connecting the visitor and the selected owner, wherein the visitor and the selected owner use different communication methods and said communication channel establisher is further configured to mediate between the different communication methods, using the communication channel.

6. The system of claim, further comprising a message enhancer, configured to enhance a message transmitted through a communication channel between the visitor and the selected owner.

7. The system of claim 1, wherein the selection criterion comprises availability of an owner through a communication method.

8. The system of claim 1, further comprising an owner communication method definer, operable for defining a communication method for an owner.

9. The system of claim 1, further comprising a content owner assigner, operable for assigning an owner to a content item.

10. The system of claim 1, further comprising an availability data provider, configured to provide the visitor with data indicative of availability of at least a first owner pre-assigned to the content item, through at least one communication method pre-defined for the first owner.

11. The system of claim 1, wherein at least one of the communication methods pre-defined for the owner is based on an instant messaging service.

12. The system of claim 1, wherein the content item is presented to the visitor through a web page.

13. The system of claim 1, wherein the content item is an object of an application running on a computer used by the visitor.

14. The system of claim 1, wherein the visitor and the selected owner are available through different communication methods.

15. The system of claim 1, wherein the visitor and the selected owner are available through different instant messaging services.

16. The system of claim 1, further comprising a client agent embedded in the content item and configured to send the data to the interaction data receiver.

17. A computer implemented method for communication in context of content, the method comprising steps the computer is programmed to perform, the steps comprising:
on a server computer, receiving data indicating occurrence of an interaction of a visitor with a content item presented on a computer remote from the server computer; and
automatically selecting at least one owner among a group of owners pre-assigned to the content item and a communication method among a group of communication methods pre-defined for the selected owner, for dynamically connecting the visitor and the selected owner, using the received data and according to a pre-defined selection criterion.

18. The method of claim 17, further comprising dynamically establishing a communication channel connecting the visitor and the selected owner, using the selected communication method.

19. A system for communication in context of content, the system comprising:
an interaction data receiver, implemented on a server computer and configured to receive data indicating occurrence of an interaction of a first party with a content item on a computer remote from the server computer; and
a communication method selector, in communication with said interaction data receiver, configured to select at least one second party among a group of parties pre-assigned to the content item and a communication method among a group of communication methods pre-defined for the second party, for dynamically connecting the first party and the second party, using the received data and according to a pre-defined selection criterion.

20. The system of claim 19, further comprising a communication channel establisher, configured to dynamically establish a communication channel connecting the parties, using the selected communication method.

21. The system of claim 19, wherein at least one of the parties is a computer application.

22. The system of claim 19, wherein the parties are computer applications, further comprising a communication channel establisher, configured to dynamically establish a communication channel connecting the parties, using the selected communication method, and to use the established communication channel for sharing screen content between the parties.
